(19) United States
(12) Patent Application Publication
(10) Pub. No.: US 2016/0140204 A1
(43) Pub. Date: May 19, 2016

(54) COMPUTER IMPLEMENTED METHODS AND SYSTEMS FOR EFFICIENT DATA MAPPING REQUIREMENTS ESTABLISHMENT AND REFERENCE

(71) Applicants: Sherry Ann Brown, New York, NY (US); Gary Wayne Hughes, McKinney, TX (US)

(72) Inventors: Sherry Ann Brown, New York, NY (US); Gary Wayne Hughes, McKinney, TX (US)

(73) Assignee: APTIMAP LLC, Austin, TX (US)

(21) Appl. No.: 14/546,350

(22) Filed: Nov. 18, 2014

(51) Int. Cl. G06F 17/30; G06N 99/00

(52) U.S. Cl. CPC G06F 17/30592; G06F 17/30563; G06N 99/005

(57) ABSTRACT

The current invention can provide methods and systems for creating and referencing data mapping requirements in a highly efficient, effective manner by providing functionality needed at the beginning, ending, and throughout the life of a data warehousing project. This can be accomplished through the ability to: prioritize fields of interest, provide visualization of the data mapping, set the ETL rules, provide progress and filtering functionality based on current status, provide learned intelligent tips for the next needed functionality, provide source comparisons per applied learning, apply learning for product enhancement, provide data profiling, provide data lineage, and have all of this functionality work together to achieve these capabilities.

### CROSS REFERENCE TO RELATED APPLICATION

This application claims the benefit of the following provisional application which is hereby incorporated by reference in its entirety: U.S. Pat. App. No. 61/906,403 filed on Nov. 19, 2013 and entitled “COMPUTER IMPLEMENTED METHODS AND SYSTEMS FOR EFFICIENT DATA MAPPING REQUIREMENTS ESTABLISHMENT AND REFERENCE.”

### FIELD OF THE INVENTION

The present invention relates to the fields of Data Mapping and Artificial Intelligence.

### BACKGROUND

A Data Warehouse is used to store information in a manner that is much more conducive for reporting and analytics rather than operational use. When utilized properly, the reporting and analytics can result in a company quickly, easily, and more cost-effectively knowing not just its financial status, but also areas that are in need of attention and those that are excelling (i.e., the latter of which can be used as potential models for the former).

Since the data itself is used differently for reporting and analytics versus operational needs, the structures of the respective supporting databases are typically also different. Therefore, data mapping requirements are essential for knowing how to properly populate the data warehouse from the operational information. Naturally, once the requirements are determined, they must be implemented; however, without proper requirements, the implementation is not typically very effective.

To set the requirements properly, it is a very detailed effort. Every source and target field must be considered for direct mapping and/or for any applicable extract transform load (ETL) rules. There are often hundreds to thousands of fields to consider. This is a very tedious, inefficient effort with the tools available today.

Further, as is common with any endeavor, the priority of effort must be determined so resources can focus on the most beneficial fields to finish first. Throughout and beyond this initial effort, constant reference is needed to identify and/or review what has and has not been completed for both requirements and validation. The types of information that are helpful to accomplish this are data profiling, data lineage, progress status, and other metadata. The effort required to address these pieces only adds to the tediousness and inefficiency.

Typically, the requirements are established using a common spreadsheet tool. Utilizing this tool is tedious and inefficient since this approach uses free-form data entry and, by far, the majority of the effort is manual. The ability to copy and paste information, although helpful, requires the user to manage the locations of source and target fields within the spreadsheet and to ensure they are in proper alignment. Further, the data profiling, data lineage, progress status, and other metadata referencing is largely manual, even when using a tool such as a local database.

The above can apply for any field mapping effort whether or not directly related to the creation or re-creation of a data warehouse. An example is when tables and fields from the same or different sources (or data stores) need to be compared for various reasons.

Regarding the related art, there are many vendor options and extract, transform, load (ETL) tools to implement the results of the requirements but not necessarily to set the requirements before or independently of implementation (i.e., one example is business requirements). The vendor options are typically focused on how the information relates and will be or has been implemented in their tools specifically. The ETL tools offer the ability to map the requirements initially, but the purpose of the mapping is to create the ETL itself. Its intention is not to reflect the business perspective but to create the data warehouse itself. As a result, neither option in these categories accomplishes the additional goals mentioned above.

Further, simply introducing software to address the goals can add another layer of complexity to an already resource intensive process. As a result, the invention is needed to alleviate the tediousness and inefficiency within the data mapping prioritization, requirements, validation, and reference effort, allowing companies to appropriately focus their time, effort, and money on reaching the value-added goal of creating and utilizing the information within a data warehouse to much more quickly move their business forward. Further, this should be accomplished without adding the complexity of learning a new tool.

### SUMMARY

In preferred examples the current invention can provide methods and systems for creating and referencing data mapping business requirements in a highly efficient, effective manner by providing functionality needed at the beginning, ending, and throughout the life of a data warehousing and/or any field mapping project. This can be accomplished at least partially through the ability to: prioritize fields of interest, provide visualization of data mappings, set ETL rules, provide progress and filtering functionality based on current status, provide learned intelligence tips for the next needed functionality, provide source comparisons per applied learning, apply system learning for product enhancement, provide data profiling, provide data lineage, and have all of this functionality work together to achieve these capabilities.

According to an example of the present invention, a computer implemented method that provides prioritization, requirements establishment, validation, and reference that can be used to create and reference a data warehouse (and/or any field mapping effort) includes the steps of: prioritizing one or more fields; prioritizing one or more sources; performing data profiling on said one or more fields and one or more sources; providing results of said data profiling; performing a second prioritizing of said one or more fields based at least on the data profiling; comparing one or more of said one or more fields for auto mapping suggestions and for contribution to a learning process; generating a set of auto mapping decisions for one or more of said one or more fields from said auto mapping suggestions; displaying said set of auto mapping decisions; capturing results of said auto mapping decisions for contribution to said learning process; and merging said one or more fields from said one or more sources into one or more data stores.

According to an example of the present invention, the method further includes the steps of: establishing data lineage for one or more of said one or more sources; and displaying data lineage for one or more of said one or more sources.

According to an example of the present invention, the method further includes the steps of: providing a user interface to establish data mapping and ETL rules in various formats; displaying said data mapping and/or ETL rules requirements via said user interface in one or more formats; and displaying a data dictionary, wherein said data dictionary provides a detailed explanation of properties and status of a project as well as a detailed explanation of one or more of said one or more sources, and one or more of said one or more fields.

According to an example of the present invention, the method further includes the steps of: capturing statistics for one or more of said one or more fields and one or more sources; capturing statistics of product usage; and generating one or more sets of key statistics from said statistics for one or more of said one or more fields and one or more sources and said statistics of product usage.

According to an example of the present invention, the method further includes the steps of: displaying a portion of said one or more sets of key statistics associated with field and source statistics; and displaying a portion of said one or more sets of key statistics associated with said field and source statistics per one or more attributes associated with said field and source statistics.

According to an example of the present invention, the method further includes the steps of: displaying key points of unused functionality in software for user knowledge and guidance, wherein said key points are obtained from said one or more sets of key statistics; and managing provided key points of unused functionality in software.

According to an example of the present invention, the method further includes the step of applying said one or more sets of key statistics to enhance learning process for comparison suggestions.

According to an example of the present invention, the method further includes the step of applying said one or more sets of key statistics to enhance learning process for software improvements.

According to an example of the present invention, the method further includes the step of applying said one or more sets of key statistics to enhance learning process for automatically displaying key points of unused functionality in software.

According to an example of the present invention, the method further includes the step of capturing results of user decisions on one or more mapped fields for contribution to the learning process.

According to an example of the present invention, a computer implemented system that provides prioritization, requirements establishment, validation, and reference that can be used to create and reference a data warehouse (and/or any field mapping effort), includes: one or more network connected computing devices, wherein each computing device comprises a processor, a memory, one or more input/output interfaces, and one or more applications, and wherein the one or more network connected computing devices are operably connected and are configured to: prioritize one or more fields; prioritize one or more sources; perform data profiling on said one or more fields and one or more sources; provide results of said data profiling; perform a second prioritizing of said one or more fields based at least on the data profiling; compare one or more of said one or more fields for auto mapping suggestions and for contribution to a learning process; generate a set of auto mapping decisions for one or more of said one or more fields from said auto mapping suggestions; display said set of auto mapping decisions; capture results of said auto mapping decisions for contribution to said learning process; and merge said one or more fields from said one or more sources into one or more data stores.

According to an example of the present invention, the one or more network connected computing devices are further configured to: establish data lineage for one or more of said one or more sources; and display data lineage for one or more of said one or more sources.

According to an example of the present invention, the one or more network connected computing devices are further configured to: provide a user interface to establish data mapping and ETL rules in various formats; display said data mapping and/or ETL rules requirements via said user interface in one or more formats; and display a data dictionary, wherein said data dictionary provides a detailed explanation of properties and status of a project as well as a detailed explanation of one or more of said one or more sources, and one or more of said one or more fields.

According to an example of the present invention, the one or more network connected computing devices are further configured to: capture statistics for one or more of said one or more fields and one or more sources; capture statistics of product usage; and generate one or more sets of key statistics from said statistics for one or more of said one or more fields and one or more sources and said statistics of product usage.

According to an example of the present invention, the one or more network connected computing devices are further configured to: display a portion of said one or more sets of key statistics associated with field and source statistics; and display a portion of said one or more sets of key statistics associated with said field and source statistics per one or more attributes associated with said field and source statistics.

According to an example of the present invention, the one or more network connected computing devices are further configured to: display key points of unused functionality in software for user knowledge and guidance, wherein said key points are obtained from said one or more sets of key statistics; and manage provided key points of unused functionality in software.

According to an example of the present invention, the one or more network connected computing devices are further configured to apply said one or more sets of key statistics to enhance learning process for comparison suggestions.

According to an example of the present invention, the one or more network connected computing devices are further configured to apply said one or more sets of key statistics to enhance learning process for software improvements.

According to an example of the present invention, the one or more network connected computing devices are further configured to apply said one or more sets of key statistics to enhance learning process for automatically displaying key points of unused functionality in software.

According to an example of the present invention, the one or more network connected computing devices are further configured to capture results of user decisions on one or more mapped fields for contribution to the learning process.

The foregoing summary of the present invention with the preferred examples should not be construed to limit the scope of the invention. It should be understood and obvious to one skilled in the art that the examples of the invention thus described may be further modified without departing from the spirit and scope of the invention.

### BRIEF DESCRIPTION OF THE DRAWINGS

FIG. 1 illustrates an example overview of a methods flow in accordance with various examples of the present invention.

FIG. 2 shows an application server overview example in accordance with various examples of the present invention.

FIG. 3 illustrates a client device overview example in accordance with various examples of the present invention.

FIG. 4 shows a database server overview example in accordance with various examples of the present invention.

FIG. 5 shows an example overview of the interaction of key dependencies between the methods and systems for a user interface and background applications in accordance with various examples of the present invention.

FIG. 6 illustrates an example of a source management work area for specification of the source-to-target field mapping including an extract transform load (ETL) rules in accordance with various examples of the present invention.

FIG. 7 presents an example of a user interface for a source comparison work area in accordance with various examples of the present invention.

FIGS. 8, 8A, 8B, 8C, and 8D show an example of learning methods and systems for the source comparison functionality in accordance with various examples of the present invention.

FIG. 9 shows an example of a progress status and filtering guidance area in accordance with various examples of the present invention.

FIG. 10 presents an example of a user interface for the software usage guidance area in accordance with various examples of the present invention.

FIG. 11 shows an example of learning methods and systems for a software usage guidance functionality in accordance with various examples of the present invention.

FIG. 12 presents an example of a resulting data mapping and extract, transform, load (ETL) requirements view in accordance with various examples of the present invention.

FIG. 13 illustrates an example of a field summary view (which can relate to a prioritization and validation view) in accordance with various examples of the present invention.

FIG. 14 shows an example of a source summary view (which can relate to a quick source status overview) in accordance with various examples of the present invention.

FIGS. 15, 15A, 15B, 15C, and 15D present an example of an overview of the administrative statistics and licensing aspects of the methods and systems in accordance with various examples of the present invention.

FIG. 16 shows an example of the data dictionary view (which can relate to a more detailed explanation of the properties and status of the project, source, and field) in accordance with various examples of the present invention.

### DETAILED DESCRIPTION

The invention involves several aspects regarding how the various pieces interact with each other as well as the data received from the server or client and vice-versa. Examples illustrate the methods and systems for an easy-to-use, intuitive tool that takes advantage of the resulting data received by the server or client per the work the user already has to do and then takes it to a whole new level.

According to certain examples of the present invention, the systems described herein can capture certain information simply by receiving data from imported files and manual effort; comparing sources systematically to each other (i.e., source-to-target, with the latter also being called a source throughout most of this document); learning to apply previous rules and processes to new sources; providing an ongoing status for the user, implementer, and other interested parties; providing information to guide the user at key points toward the next beneficial functionality within the methods and systems to utilize, describing how to do it and why it's important; providing data lineage simply by utilizing the data mapping and ETL requirements which have to be completed regardless; and by providing additional documentation of the sources and fields largely based on the result of the work required to have already been performed (i.e., the information received by the server and client for that work). The system can constantly gather various statistics about its use per functionality and user interactions to continuously improve its usability. Additionally, the system can generate SQL statements to create the target sources and the source-to-target SQL.

Accordingly, a preferred example of the computer implemented methods and system of the present invention is now presented. As implied, this represents just one example, and it should be understood that other examples could occur that would be covered by this application. Further, since the learning aspects of these methods and systems are significant, it should be noted that some of the examples and processes are expected to change over time as a direct result of the methods and systems presented herein and are within the spirit and scope of the invention. It should be understood and obvious to one skilled in the art that the examples of the invention thus described may be further modified without departing from the spirit and scope of the invention.

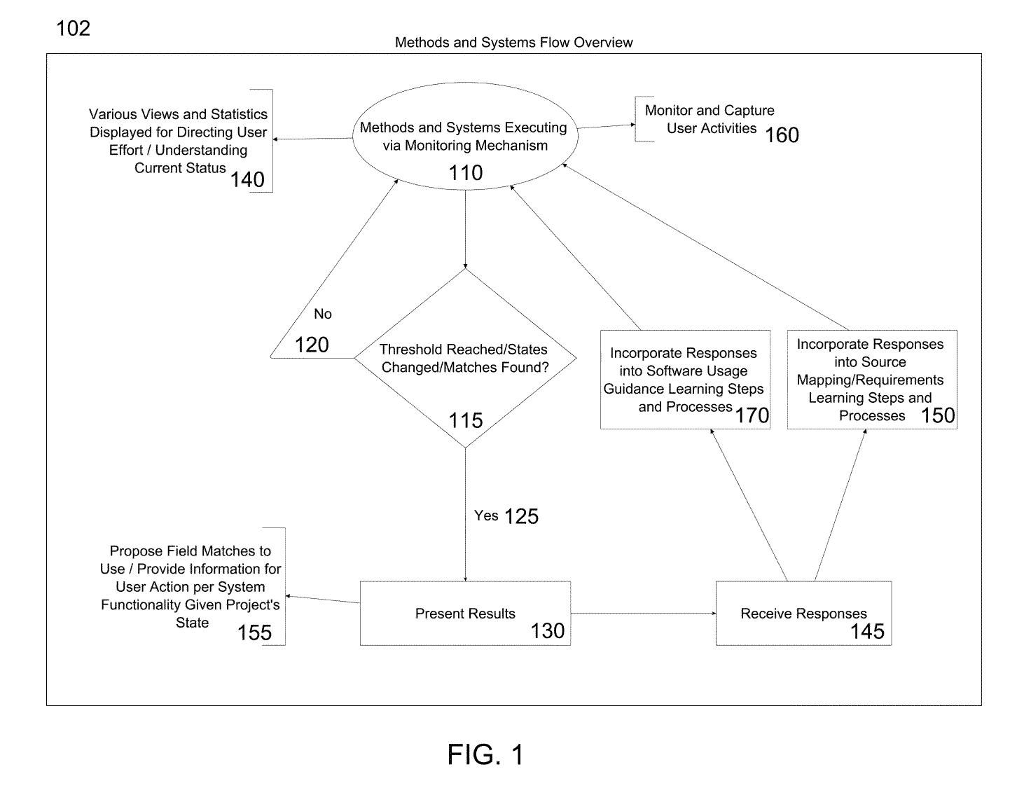

FIG. 1 shows one example of the method and systems flow overview, in accordance with an example of the present invention. The methods and systems 102 can continuously monitor the data on the servers and clients per computer implemented steps and processes typically run by a processor (also called “algorithms”) and/or event triggers 110. Depending on their purpose, to be explained later, these algorithms and/or triggers can check for thresholds being reached, states being changed, and/or field matches being found 115. If neither occurs 120, the algorithms and/or event triggers can continue monitoring for those events or situations 110.

When a threshold is reached, a state is changed, and/or a field match is found 125, the results can be presented 130. The results can be either proposed field matches or additional system functionality that is helpful for a user given status of a project (per the state changes and/or achieved thresholds) 155. The methods and systems 102 can receive a response from the user 145 and can incorporate the response into a source mapping/requirements learning steps and processes 150, 110 and/or a software usage guidance learning steps and processes 170, 110. Further, the methods and systems 102 can continuously monitor and capture various user activities 160 to integrate them into the algorithms and/or event triggers 110. Finally, various views and statistics can be displayed by the methods and systems 102 to help the user direct his/her effort and for understanding of the current status of the project 140.

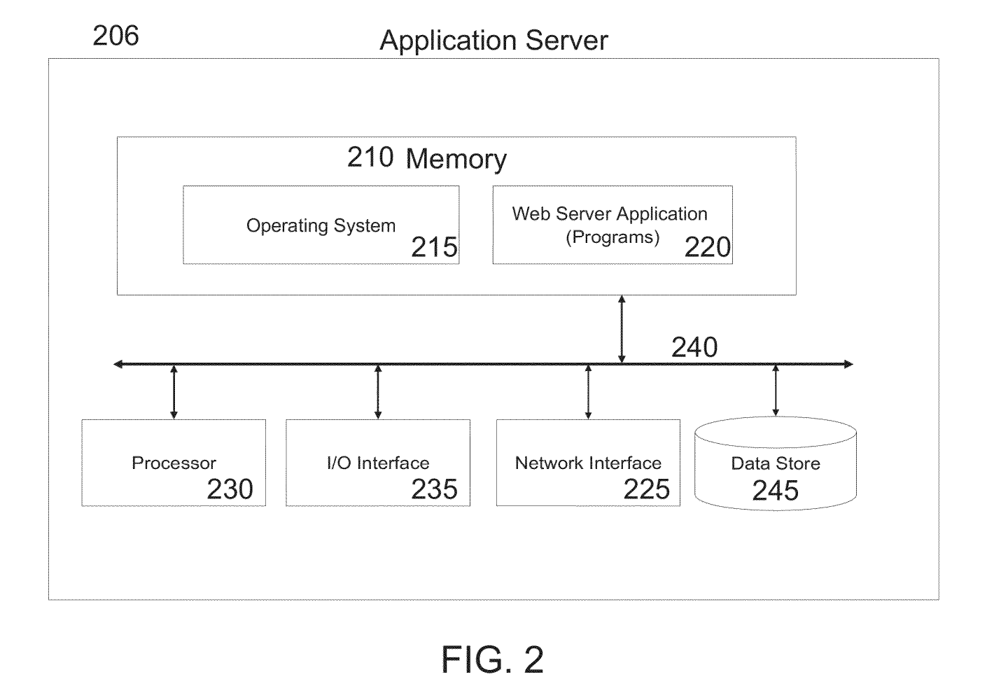

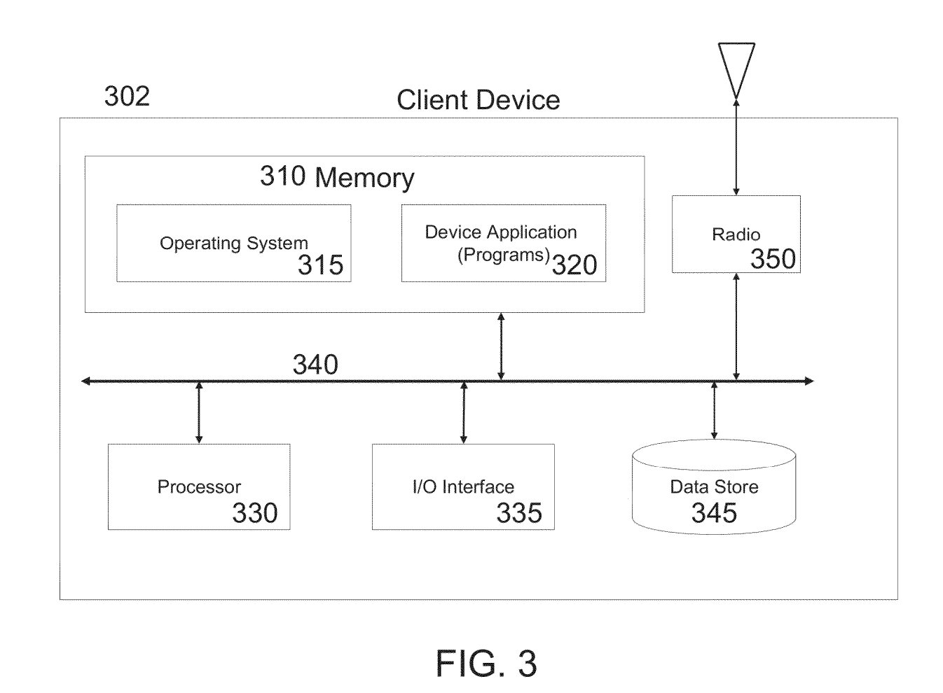

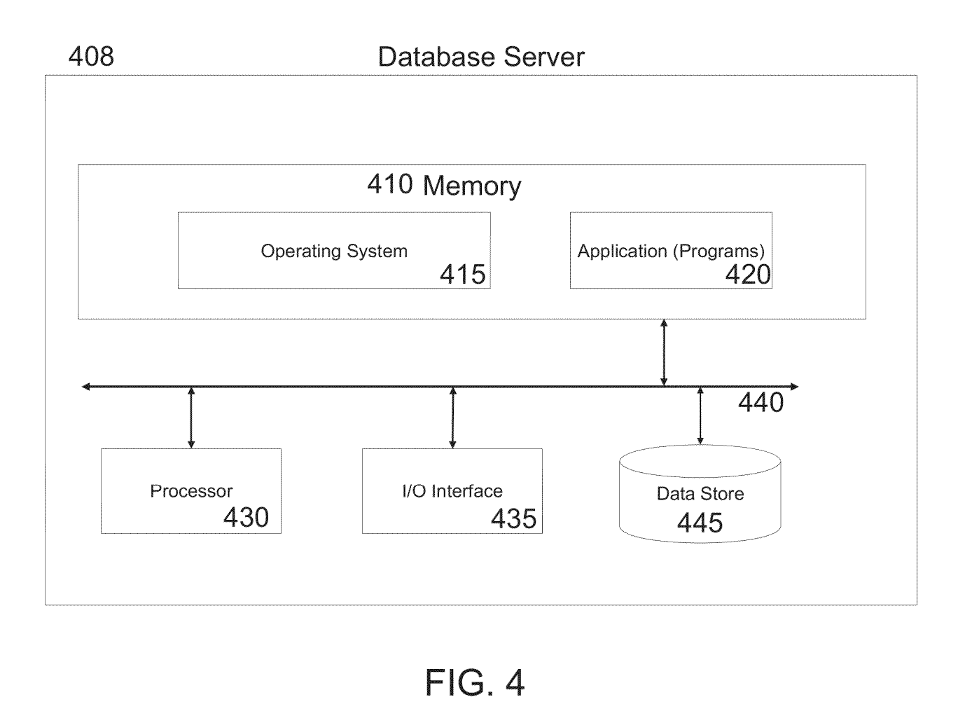

In a preferred example of the present invention, the methods and systems 102 may utilize various machines to run. That is, methods and processes described herein are performed by a processor running on a computer. This can include an application server, client device (including a user device utilizing a web browser or other application for sending/receiving data over a network), and database server as illustrated in FIG. 2, FIG. 3, and FIG. 4, respectively. In other examples, the system may be run on a single machine. In still further examples, one or more of the machines associated with the system may be provided virtually, such as via a virtual server running on a multi-tenant platform. One of ordinary skill in the art would appreciate that there are numerous configurations that could be utilized, utilizing any number of machines, and examples of the present invention are contemplated for use with any number of machines and/or configurations.

Referring now to FIG. 2, in an example, a block diagram illustrates a server 206 which may be used in the system or standalone. The server 206 may be a digital computer that, in terms of hardware architecture, generally includes a processor 230, input/output (I/O) interfaces 235, network interface 225, a data store 245, and memory 210. It should be appreciated by those of ordinary skill in the art that FIG. 2 depicts the server 206 in an oversimplified manner, and a practical example may include additional components and suitably configured processing logic to support known or conventional operating features that are not described in detail herein. The components (230, 235, 225, 245, and 210) are communicatively coupled via a local interface 240. The local interface 240 may be, for example but not limited to, one or more buses or other wired or wireless connections, as is known in the art. The local interface 240 may have additional elements, which are omitted for simplicity, such as controllers, buffers (caches), drivers, repeaters, and receivers, among many others, to enable communications. Further, the local interface 240 may include address, control, and/or data connections to enable appropriate communications among the aforementioned components. One of ordinary skill in the art would appreciate that servers that could be utilized with examples of the present invention may be comprised of additional or fewer components, and examples of the present invention are contemplated for use with any appropriate type of server or other computing device.

In a preferred example, the processor 230 is a hardware device for executing software instructions. The processor 230 may be any custom made or commercially available processor, a central processing unit (CPU), an auxiliary processor among several processors associated with the server 206, a semiconductor-based microprocessor (in the form of a microchip or chip set), or generally any device for executing software instructions. In other examples, the processor may be a virtual processor, such as those provided by a multi-tenant environment and supported by underlying physical hardware. One of ordinary skill in the art would appreciate that there are numerous processors and processor types that could be utilized with examples of the present invention, and examples of the present invention are contemplated for use with any appropriate processor.

When the server 206 is in operation, the processor 230 is configured to execute software stored within the memory 210, to communicate data to and from the memory 210, and to generally control operations of the server 206 pursuant to the software instructions. The I/O interfaces 235 may be used to receive user input from and/or for providing system output to one or more devices or components. User input may be provided via, for example, a keyboard, touch pad, and/or a mouse. System output may be provided via a display device and a printer (not shown). I/O interfaces 235 may include, but are not limited to, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface. One of ordinary skill in the art would appreciate that there are numerous types of I/O interfaces that could be utilized with examples of the present invention, and examples of the present invention are contemplated for use with any appropriate I/O interface.

The network interface 225 may be used to enable the server 206 to communicate on a network, such as the Internet, the WAN 101, the enterprise 200, and the like. The network interface 225 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 225 may include address, control, and/or data connections to enable appropriate communications on the network. One of ordinary skill in the art would appreciate that there are numerous types of network interfaces that could be utilized with examples of the present invention, and examples of the present invention are contemplated for use with any appropriate network interface.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), non-transient media, and combinations thereof. Moreover, the memory 210 may incorporate electronic, magnetic, optical, and/or other types of storage media. Note that the memory 210 may have a distributed architecture, where various components are situated remotely from one another, but can be accessed by the processor 230. The software in memory 210 may include one or more software programs, each of which includes an ordered listing of executable instructions for implementing logical functions. The software in the memory 210 may include a suitable operating system (O/S) 215 and the web server application (one or more programs) 220. One of ordinary skill in the art would appreciate that there are numerous types of memory that could be utilized with examples of the present invention, and examples of the present invention are contemplated for use with any appropriate memory type.

The operating system 215 essentially controls the execution of other computer programs, such as the web server application (one or more programs) 220, and provides scheduling, input-output control, file and data management, memory management, and communication control and related services. The operating system 215 may be, for example Windows NT, Windows 2000, Windows XP, Windows Vista, Windows 7, Windows 8, Windows Server 2003/2008 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The web server application (one or more programs) 220 may be configured to implement the various processes, algorithms, methods, techniques, etc. described herein.

A data store 245 may be used to store data. The data store 245 may include any of volatile memory elements (e.g., random access memory (RAM, such as DRAM, SRAM, SDRAM, and the like)), nonvolatile memory elements (e.g., ROM, hard drive, tape, CDROM, and the like), non-transient media, and combinations thereof. Moreover, the data store 245 may incorporate electronic, magnetic, optical, and/or other types of storage media. In one example, the data store 245 may be located internal to the server 206 such as, for example, an internal hard drive connected to the local interface 240 in the server 206. Additionally, in another example, the data store 245 may be located external to the server 206 such as, for example, an external hard drive connected to the I/O interfaces 235 (e.g., SCSI or USB connection). In a further example, the data store 245 may be connected to the server 206 through a network, such as, for example, a network attached file server.

Referring to FIG. 3, in an example, a block diagram illustrates a client device 302, which may be used in the system or the like. The client device 302 can be a digital device that, in terms of hardware architecture, generally includes a processor 330, input/output (I/O) interfaces 335, a radio 350, a data store 345, and memory 310. It should be appreciated by those of ordinary skill in the art that FIG. 3 depicts the client device 302 in an oversimplified manner, and a practical example may include additional components and suitably configured processing logic to support known or conventional operating features that are not described in detail herein. The components (330, 335, 350, 345, and 310) are communicatively coupled via a local interface 340. The local interface 340 can be, for example but not limited to, one or more buses or other wired or wireless connections, as is known in the art. The local interface 340 can have additional elements, which are omitted for simplicity, such as controllers, buffers (caches), drivers, repeaters, and receivers, among many others, to enable communications. Further, the local interface 340 may include address, control, and/or data connections to enable appropriate communications among the aforementioned components.

In a preferred example, the processor 330 is a hardware device for executing software instructions. The processor 330 can be any custom made or commercially available processor, a central processing unit (CPU), an auxiliary processor among several processors associated with the client device 302, a semiconductor-based microprocessor (in the form of a microchip or chip set), or generally any device for executing software instructions. In other examples, the processor may be a virtual processor, such as those provided by a multi-tenant environment and supported by underlying physical hardware. One of ordinary skill in the art would appreciate that there are numerous processors and processor types that could be utilized with examples of the present invention, and examples of the present invention are contemplated for use with any appropriate processor.

When the client device 302 is in operation, the processor 330 is configured to execute software stored within the memory 310, to communicate data to and from the memory 310, and to generally control operations of the client device 302 pursuant to the software instructions. In an example, the processor 330 may include a mobile optimized processor such as optimized for power consumption and mobile applications. The I/O interfaces 335 can be used to receive user input from and/or for providing system output to one or more devices or components. User input can be provided via, for example, a keypad, a touch screen, a scroll ball, a scroll bar, buttons, bar code scanner, voice recognition, eye gesture, and the like. System output can be provided via a display device such as a liquid crystal display (LCD), touch screen, and the like. The I/O interfaces 335 can also include, for example, a serial port, a parallel port, a small computer system interface (SCSI), an infrared (IR) interface, a radio frequency (RF) interface, a universal serial bus (USB) interface, and the like. The I/O interfaces 335 can include a graphical user interface (GUI) that enables a user to interact with the client device 302. Additionally, the I/O interfaces 335 may further include an imaging device, i.e. camera, video camera, etc. One of ordinary skill in the art would appreciate that there are numerous types of I/O interfaces that could be utilized with examples of the present invention, and examples of the present invention are contemplated for use with any appropriate I/O interface type.

The radio 350 enables wireless communication to an external access device or network. Any number of suitable wireless data communication protocols, techniques, or methodologies can be supported by the radio 350, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. One of ordinary skill in the art would appreciate that there are numerous types of radios that could be utilized with examples of the present invention, and examples of the present invention are contemplated for use with any appropriate radio type.

The data store 345 may be used to store data. The data store 345 may include any of volatile memory elements (e.g., random access memory (RAM, such as DRAM, SRAM, SDRAM, and the like)), nonvolatile memory elements (e.g., ROM, hard drive, tape, CDROM, and the like), non-transient media, and combinations thereof. Moreover, the data store 345 may incorporate electronic, magnetic, optical, and/or other types of storage media. One of ordinary skill in the art would appreciate that there are numerous types of data stores that could be utilized with examples of the present invention, and examples of the present invention are contemplated for use with any appropriate data store type.

In some preferred examples, the client device 302 includes a global positioning system sensor configured to receive latitude and longitude coordinates from satellites (i.e. a GPS signal). In other preferred examples, the client device 302 includes an accelerometer configured to receive user initiated actions (e.g. shaking the device, moving the device in a pattern, etc.).

The memory 310 may include any of volatile memory elements (e.g., random access memory (RAM, such as DRAM, SRAM, SDRAM, etc.)), nonvolatile memory elements (e.g., ROM, hard drive, etc.), non-transient media, and combinations thereof. Moreover, the memory 310 may incorporate electronic, magnetic, optical, and/or other types of storage media. Note that the memory 310 may have a distributed architecture, where various components are situated remotely from one another, but can be accessed by the processor 330. One of ordinary skill in the art would appreciate that there are numerous types of memory that could be utilized with examples of the present invention, and examples of the present invention are contemplated for use with any appropriate memory type.

The software in memory 310 can include one or more software programs, each of which includes an ordered listing of executable instructions for implementing logical functions. In the example of FIG. 3, the software in the memory system 310 includes a suitable operating system (O/S) 315 and browser or device application (one or more programs) 320.

In certain examples, the operating system 315 essentially controls the execution of other computer programs, and provides scheduling, input-output control, file and data management, memory management, and communication control and related services. The operating system 315 may include, but is not limited to, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The browser or device application (one or more programs) 320 may include various applications, add-ons, etc. configured to provide end user functionality with the client device 302. Exemplary browser or device applications (one or more programs) 320 may include, but not be limited to, a web browser, social networking applications, streaming media applications, games, mapping and location applications, electronic mail applications, financial applications, and the like. In a typical example, the end user typically uses one or more of the programs 320 along with a network such as the system. In preferred examples, a user may access components of the system over the internet through a client device 302 configured to access an application server 206 and optionally a database server 408 (as described per the next section) via a network interface card, modem, or wireless transceiver located within or connected to the client device 302, application server 206, and database server 408.

Focusing on FIG. 4, as an example, a block diagram illustrates a database server 408 which may be used in conjunction with and operably connected to (e.g. through a network such as the internet) the application server 206 and client device 302. The database server 408 may be a digital computer that, in terms of hardware architecture, generally includes a processor 430, input/output (I/O) interfaces 435, the data store 445, and memory 410. It should be appreciated by those of ordinary skill in the art that FIG. 4 depicts the server 408 in an oversimplified manner, and a practical example may include additional components and suitably configured processing logic to support known or conventional operating features that are not described in detail herein. The components (430, 435, 445, and 410) are communicatively coupled via a local interface 440. The local interface 440 may be, for example but not limited to, one or more buses or other wired or wireless connections, as is known in the art. The local interface 440 may have additional elements, which are omitted for simplicity, such as controllers, buffers (caches), drivers, repeaters, and receivers, among many others, to enable communications. Further, the local interface 440 may include address, control, and/or data connections to enable appropriate communications among the aforementioned components.

The processor 430 is a hardware device for executing software instructions. The processor 430 may be any custom made or commercially available processor, a central processing unit (CPU), an auxiliary processor among several processors associated with the database server 408, a semiconductor-based microprocessor (in the form of a microchip or chip set), or generally any device for executing software instructions. When the server 408 is in operation, the processor 430 is configured to execute software stored within the memory 410, to communicate data to and from the memory 410, and to generally control operations of the database server 408 pursuant to the software instructions. The I/O interfaces 435 may be used to receive user input from and/or for providing system output to one or more devices or components. User input may be provided via, for example, a keyboard, touch pad, and/or a mouse. System output may be provided via a display device and a printer (not shown). I/O interfaces 435 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface. In other examples, the processor may be a virtual processor, such as those provided by a multi-tenant environment and supported by underlying physical hardware. One of ordinary skill in the art would appreciate that there are numerous processors and processor types that could be utilized with examples of the present invention, and examples of the present invention are contemplated for use with any appropriate processor.

An optional network interface may be used to enable the server 408 to communicate on a network, such as the Internet, the WAN 101, the enterprise 200, and the like. The network interface may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface may include address, control, and/or data connections to enable appropriate communications on the network. One of ordinary skill in the art would appreciate that there are numerous types of network interfaces that could be utilized with examples of the present invention, and examples of the present invention are contemplated for use with any appropriate network interface.

A data store 445 may be used to store data. The data store 445 may include any of volatile memory elements (e.g., random access memory (RAM, such as DRAM, SRAM, SDRAM, and the like)), nonvolatile memory elements (e.g., ROM, hard drive, tape, CDROM, and the like), non-transient media, and combinations thereof. Moreover, the data store 445 may incorporate electronic, magnetic, optical, and/or other types of storage media. In one example, the data store 445 may be located internal to the server 408 such as, for example, an internal hard drive connected to the local interface 440 in the server 408. Additionally, in another example, the data store 445 may be located external to the server 408 such as, for example, an external hard drive connected to the I/O interfaces 435 (e.g., SCSI or USB connection). In a further example, the data store 445 may be connected to the server 408 through a network, such as, for example, a network attached file server. One of ordinary skill in the art would appreciate that there are numerous types of data stores that could be utilized with examples of the present invention, and examples of the present invention are contemplated for use with any appropriate data store type.

The memory 410 may include any of volatile memory elements (e.g., random access memory (RAM, such as DRAM, SRAM, SDRAM, etc.)), nonvolatile memory elements (e.g., ROM, hard drive, tape, CDROM, etc.), non-transient media, and combinations thereof. Moreover, the memory 410 may incorporate electronic, magnetic, optical, and/or other types of storage media. Note that the memory 410 may have a distributed architecture, where various components are situated remotely from one another, but can be accessed by the processor 430. One of ordinary skill in the art would appreciate that there are numerous types of memory that could be utilized with examples of the present invention, and examples of the present invention are contemplated for use with any appropriate memory type.

The software in memory 410 may include one or more software programs, each of which includes an ordered listing of executable instructions for implementing logical functions. The software in the memory 410 may include a suitable operating system (O/S) 415 and an application (one or more programs) 420.

In certain examples, the operating system 415 essentially controls the execution of other computer programs, such as the application (one or more programs) 420, and provides scheduling, input-output control, file and data management, memory management, and communication control and related services. The operating system 415 may be, for example Windows NT, Windows 2000, Windows XP, Windows Vista, Windows 7, Windows 8, Windows Server 2003/2008 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The application (one or more programs) 420 may be configured to implement the various systems, processes, algorithms, methods, techniques, etc. described herein.

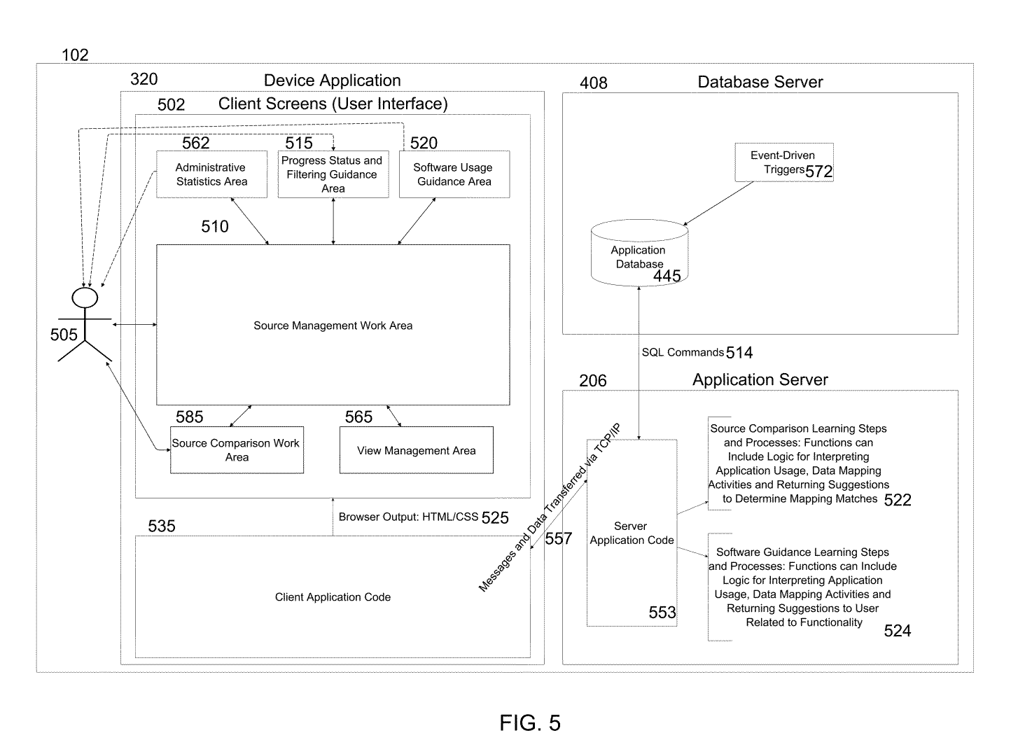

FIG. 5 provides an example of the interaction of key dependencies between the methods and systems 102 for the user interface and background applications, in accordance with an example of the present invention. In one example of the methods and systems 102, there can be four major components: device application 320, application server 206, database server 408, and the user 505. The device application 320 can consist of the client screens (i.e., user interface) 502 and the client application code 535. The application server 206 can consist of the server application code 553, and the database server 408 can include the application database 445 and event-driven triggers 572. In one example, the client application code 535 and server application code 553 can follow the model-view-controller approach.

In this example, on both the client and server sides, there can be a presentation layer, a business logic/rules layer, and a data layer within each application. For this example, in general, the client application code 535 can contain mostly business and presentation logic, and the server application code 553 can contain mostly business logic and data management. Continuing further with this example, the model-view-controller structure can manage those layers with models to handle data access and some business logic, controllers to handle additional business logic and populate views with data from models, and views that make up the presentation layer (user interface, or UI). The client-side application's data layer 535 can consist mainly of functions that transmit and request packets of tabular data to and from the server. The client-side business logic layer 535 can perform the bulk of the work on the client side by maintaining project data throughout a user's session and calling the appropriate presentation layer functions to keep the UI updated. The presentation layer 535 can build the screens and merge in the necessary data. The data handled by the client-side application 535 can already be filtered and formatted by the server side application 553 to make it easier for rendering to the screen. These responses can be results of user input from the presentation layer (i.e., from a keyboard, touch pad, touch screen, and/or mouse, etc) as well as the implementations per the methods and systems 102 of the present invention.

The server side application's data layer 553 can interface directly with the application database 445. It can retrieve requested data from the database 445 (in one example, through SQL Commands 514) and return it in the specified format. The business layer on the server 553 can be minimal, primarily filtering data based on a user's role to ensure data security. The bulk of the core application logic can run on the client 535, but there can be code executed on the server 553 to handle some business layer processes by periodically scanning through user activity logs and reacting according to defined rules. In one example, an external task scheduler can be used to periodically execute code routines within the business layer to accomplish exemplary goals of performing analysis, user notification, and maintenance operations. Messages and data transfer can occur via TCP/IP from the client application code 535 to the server application code 553 and vice versa 557. The presentation layer on the server can consist of HTML/CSS screen fragment files 557 that can be downloaded and displayed by the browser application 502, 525 as required. Additional types of responses that can be managed by the application database 445 and whose results can be sent to the server application code 553 can be executed through event-driven triggers 572. In one example, the event-driven triggers 572 can be put into motion at a certain threshold of various topics, such as the count or percentage of a source status (to be explained later) and/or changes of state, etc. Further, in the example, the application server code 553 can include the source comparison learning steps and processes 522 and the software usage guidance learning steps and processes 524.

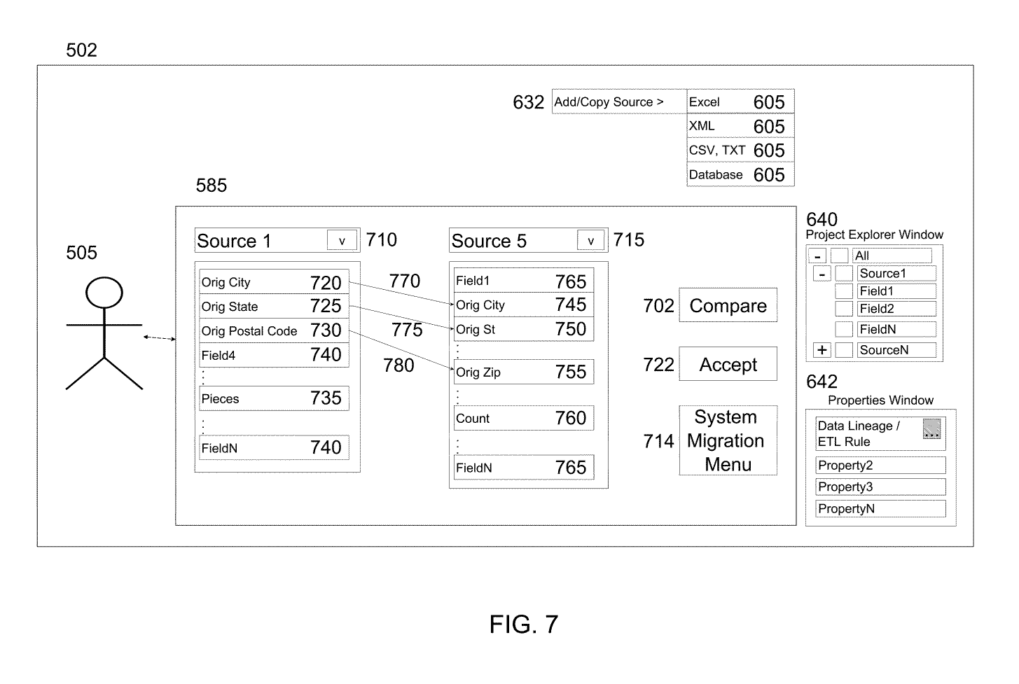

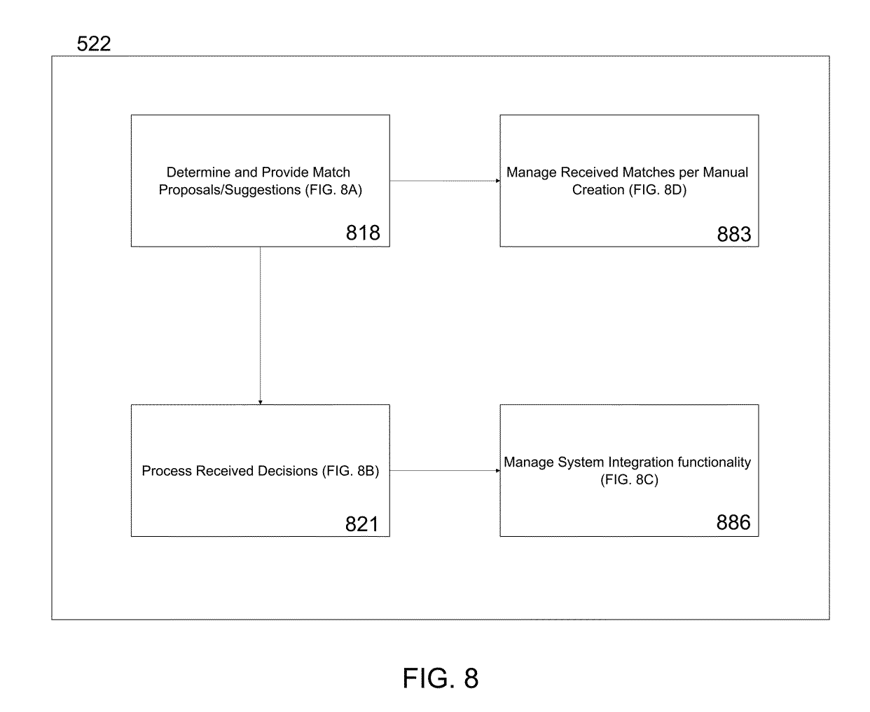

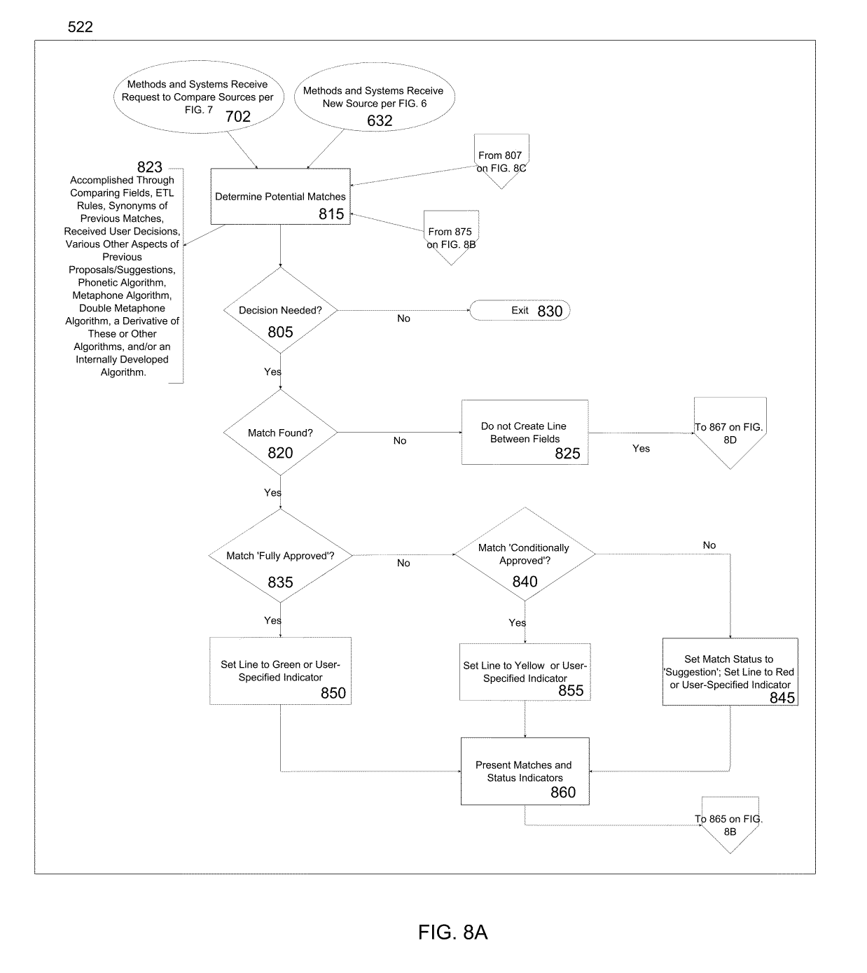

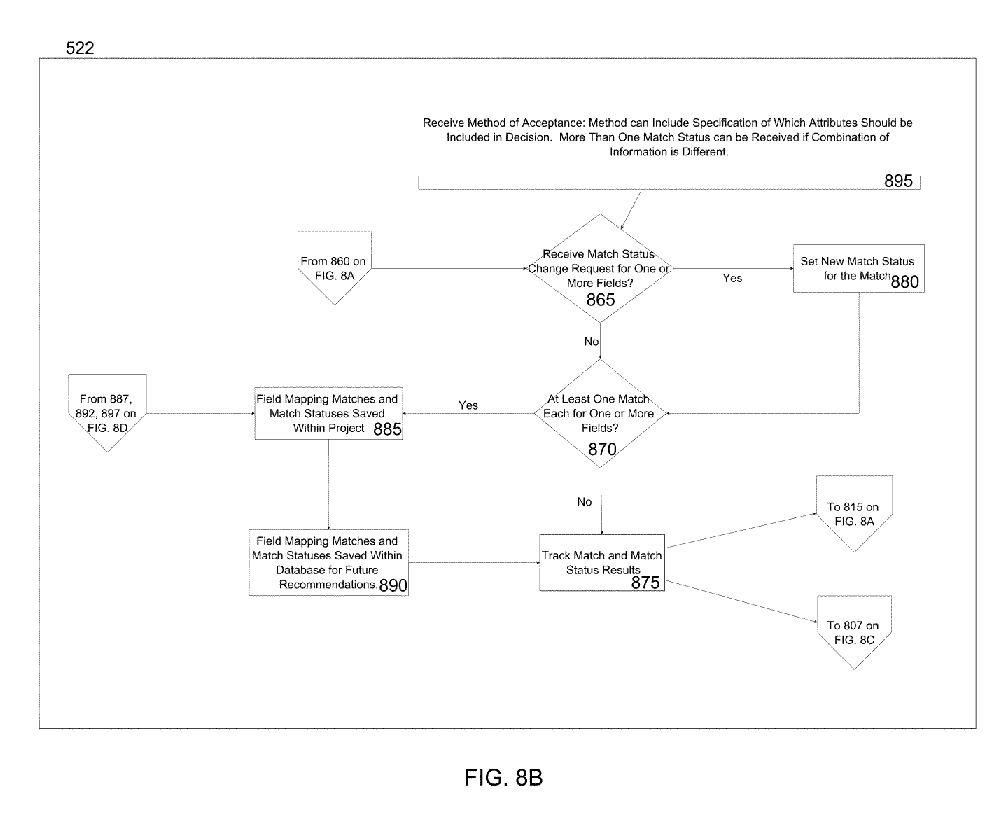

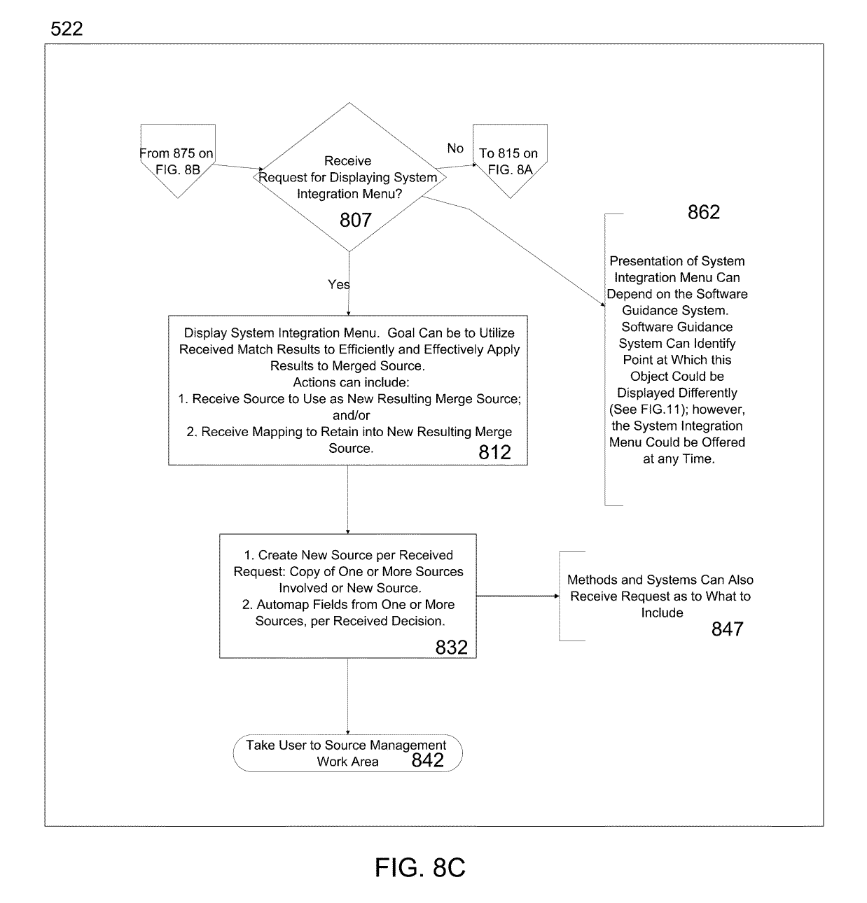

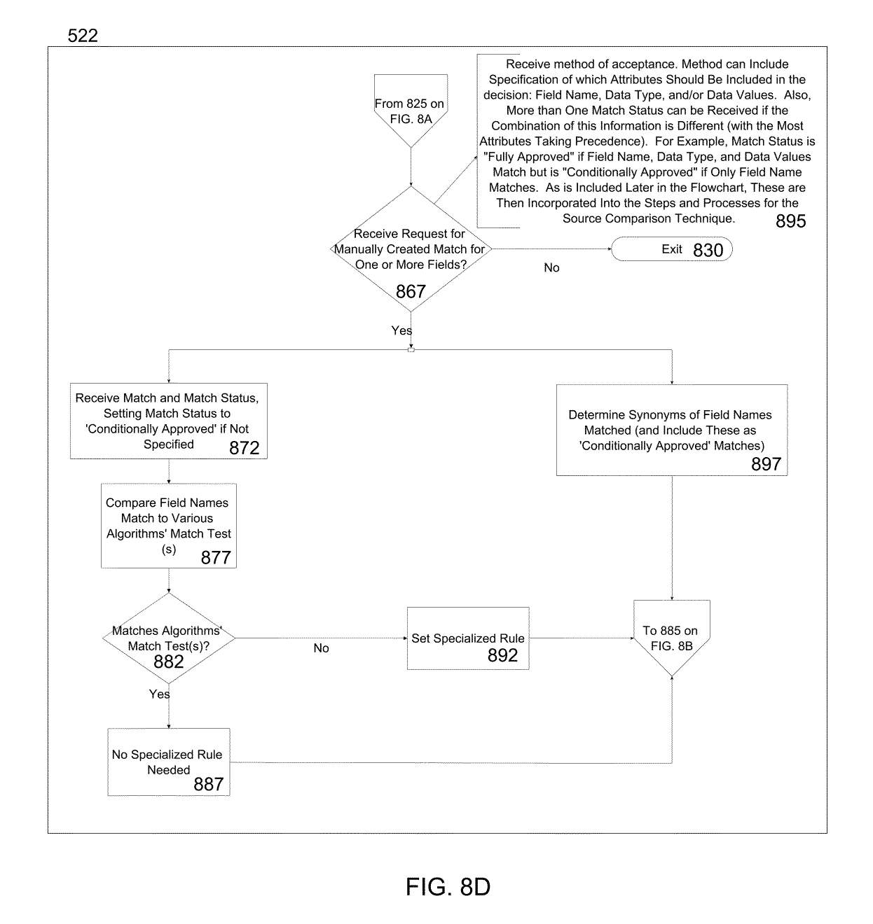

The source comparison and software usage guidance learning steps and processes (also known as “algorithms”) 522, 524, respectively, can be specialized model files that include functions for interpreting application usage and data mapping activities and returning suggestions. The source comparison learning algorithm 522 can utilize these results to automatically apply data mapping requirements to two or more sources so that the user 505 doesn't have to spend time doing that. These capabilities, along with other ways to compare sources, are described per FIG. 7 and FIGS. 8, 8A, 8B, 8C, and 8D.

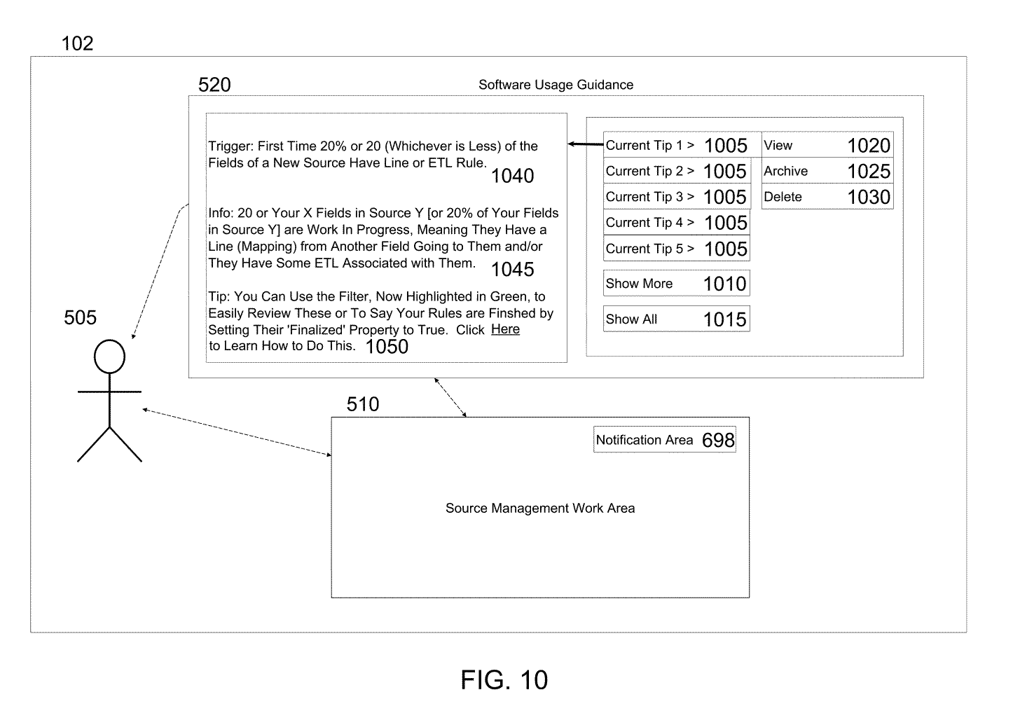

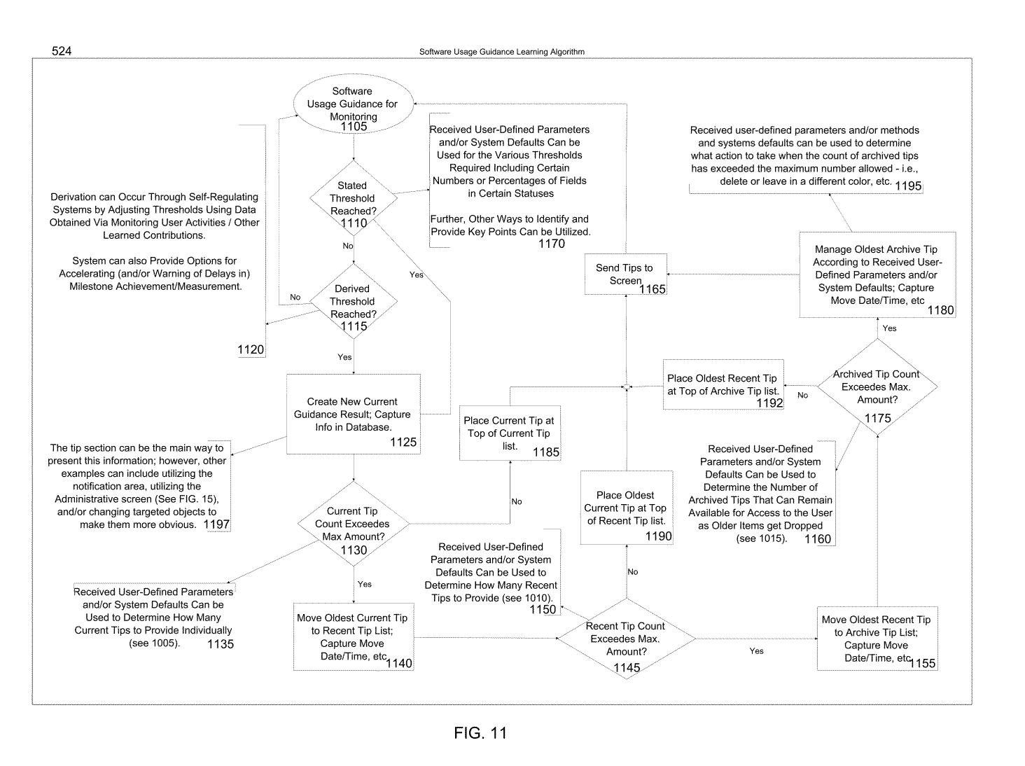

The software guidance learning algorithm 524 can utilize these results to alert the user of helpful functionality within the system at the right time and place to make use of the software to its fullest potential in the most efficient way possible (i.e., thereby not requiring the user 505 to take time and energy to know about functionality until it is needed). Further explanation of this functionality is provided per the descriptions of FIG. 10 and FIG. 11.

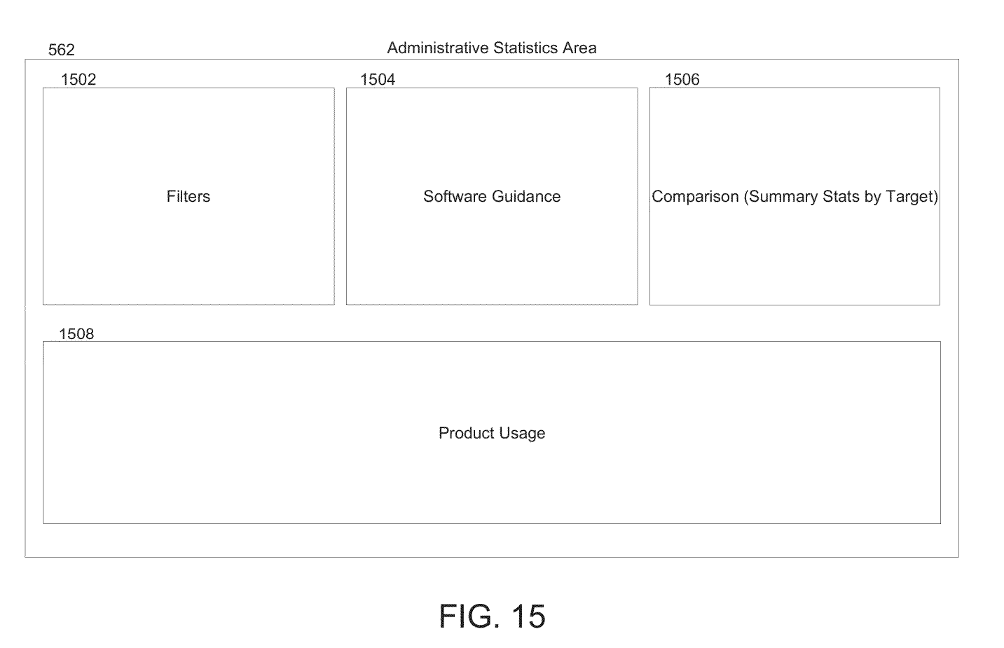

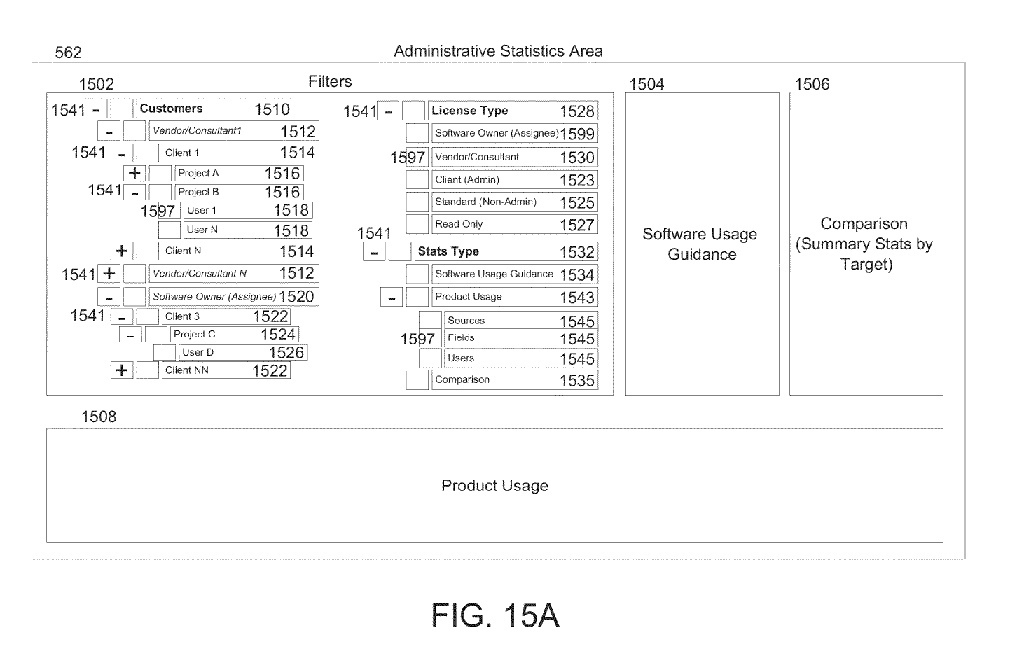

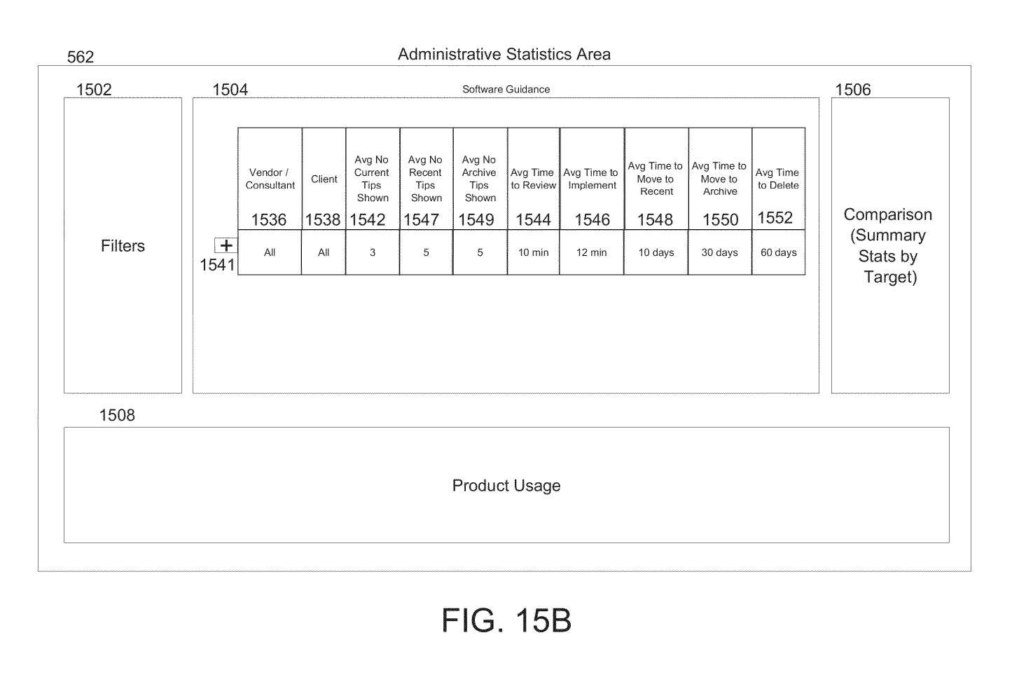

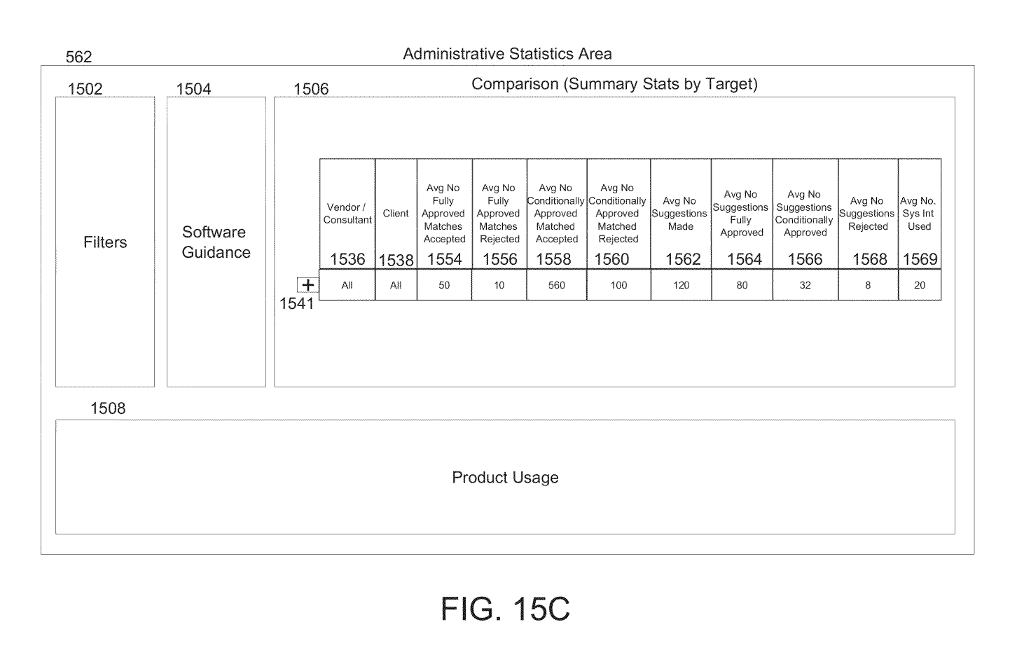

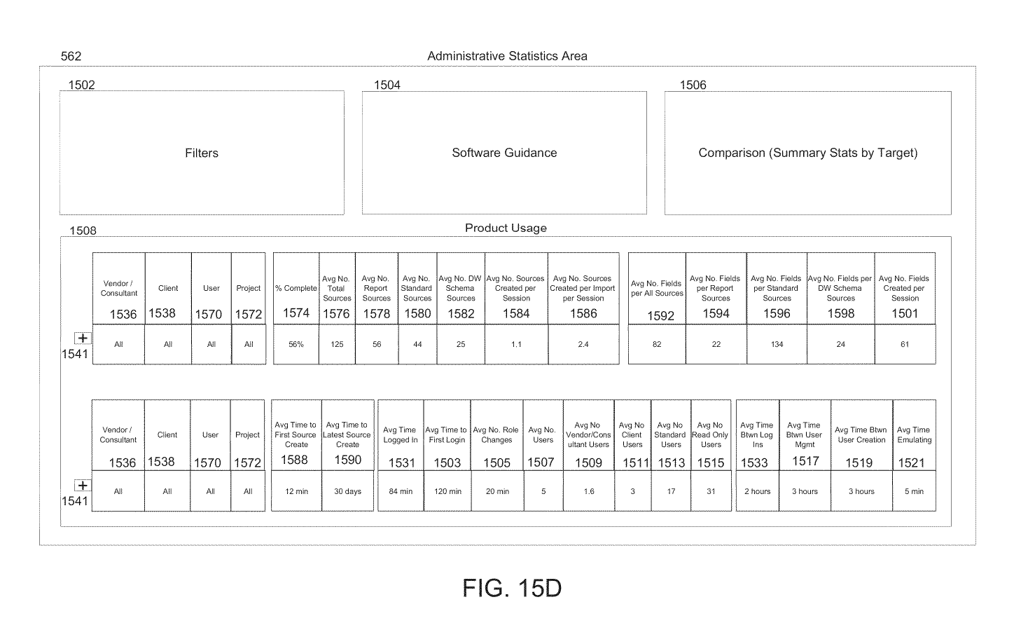

Various types of users 505 are involved with the methods and systems 102. The methods and systems 102 can receive information from or provide information to one or more users 505 who could be setting requirements, performing validation, referencing information for knowledge, etc. The user 505 may be assigned a license for his/her appropriate level of access to accomplish his/her role assignment for the project and/or methods and systems 102. FIG. 15 and FIG. 15A further delineate the response of the methods and systems 102 per licensing permissions for the user 505.

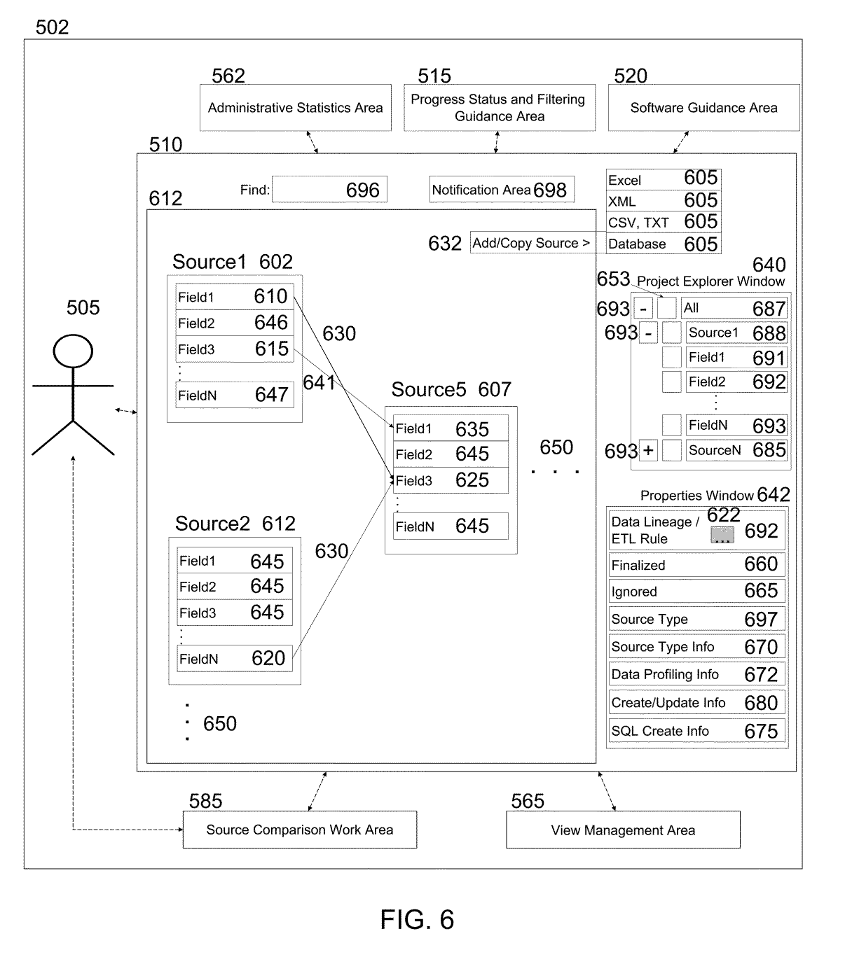

Redirecting now to the client screens (user interface) 502, these can consist of: the source management work area 510, the source comparison work area 585, progress status and filtering guidance area 515, the software usage guidance area 520, the view management area 565, and the administrative statistics area 562. The methods and systems 102 can receive requirements from the user 505 mainly through the source management work area 510 and the source comparison work area 585. The source management work area 510 can accomplish this by receiving the information provided by the user 505 in an effective and efficient manner through various tools available, as described per FIG. 6.

The source comparison work area 585 can present the user 505 the option to select (and/or create) at least two different sources to compare. Then, the source comparison learning algorithm 522 can be invoked. As previously mentioned, FIG. 7 and FIGS. 8, 8A, 8B, 8C, and 8D explain examples of these capabilities.

Referring back to FIG. 1, the algorithms and/or event triggers 110, the monitoring and capturing of the user activities 160, receiving the user's responses 135, incorporating them into the source mapping and requirements learning steps and processes 150 and into the software usage guidance learning steps and processes 170, and the check for the thresholds, state changes, and matches 115 can be further explained through the source comparison learning algorithm 522 and the software guidance learning algorithm 524. Proposing field matches and presenting new system functionality 155, presenting the results themselves 130, and the incorporation of received responses into the source mapping/requirements learning steps and processes (again) 150 and into the software usage guidance learning steps and processes (again) 170 can be further defined through the progress status and filtering guidance 515, source comparison work area 585, and the software usage guidance 520 areas. Finally, views and statistics 140 can be further described through the view management screens 565 and the administrative statistics area 562. Moving on from the overview of the source comparison work area 585 and the source comparison learning algorithm 522 examples as provided above, the overview of these areas can be presented next: progress status and filtering guidance 515, software usage guidance area 520 and software usage guidance algorithm 524, the view management area 565, and the administrative statistics area 562.

The premise of the progress status and filtering guidance 515 can be that the methods and systems 102 can provide how far along the project may be per one or more aspects by determining which fields have been started, partially started, finalized, or intentionally ignored. Given the number of sources and fields involved, the methods and systems 102 can present the user 505 this information in a manner in which he/she can quickly report on the status, figure out how much more work is needed (i.e., for work planning), and filter the categories of interest. This can enable the user, developer, or other interested parties to stay focused on the work at hand rather than be burdened with all of the fields and sources.

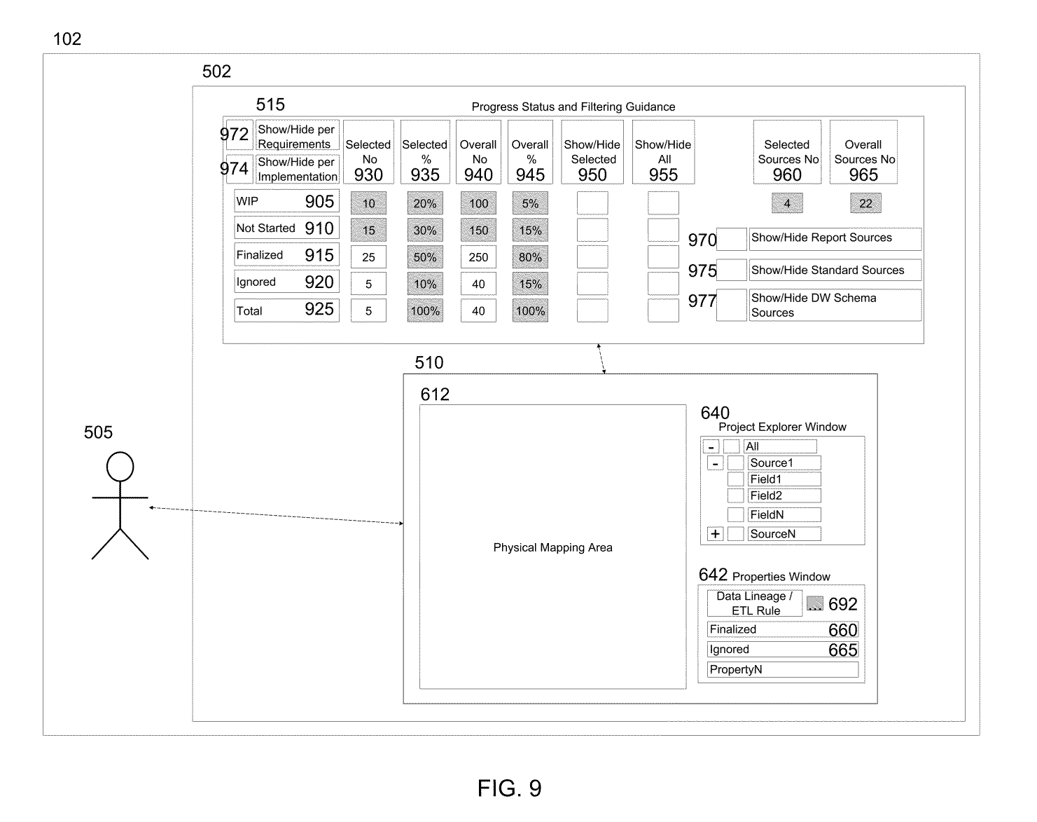

Much of this information can be provided both from the business and implementation (development) perspectives. For example, the methods and systems 102 can incorporate the progress of the implementer based on what has occurred in the methods and systems 102. This can be, for example, the number of fields and sources that: (1) have or have not been started from the development perspective (i.e., are present in the database, received an update accordingly, and/or other methods), (2) have or do not have data populated per one or more measurements (i.e., any data is present; a certain percentage of data, based on the expected data, etc), and/or (3) have or have not been validated after implementation. This can be one example, and it should be understood that many other variations and related aspects are also covered under this application. FIG. 9 further describes one example of this functionality and other interactions.

In one example, given the status of the sources and fields as well as the artificial intelligence capabilities, the methods and systems 102 can provide software usage guidance 520 for the user. Two non-limiting examples are: (1) the system can provide functionality that is needed at the point at which it is needed and (2) the system can alert the user of functionality that would maintain or enhance his/her experience at the appropriate time. The purpose of these features can be to allow the user to concentrate on his/her work at hand and not be overwhelmed by the very tool that is supposed to help him/her be more efficient. In other words, the functionality and information can be presented in a way that gently and almost unknowingly leads the user to the methods' and systems' 102 full capabilities for the maximum amount of knowledge and efficiency, but with a subtle step-by-step approach. Examples of this functionality are further explained per FIG. 10 and the associated software usage guidance learning algorithm 524 per FIG. 11.

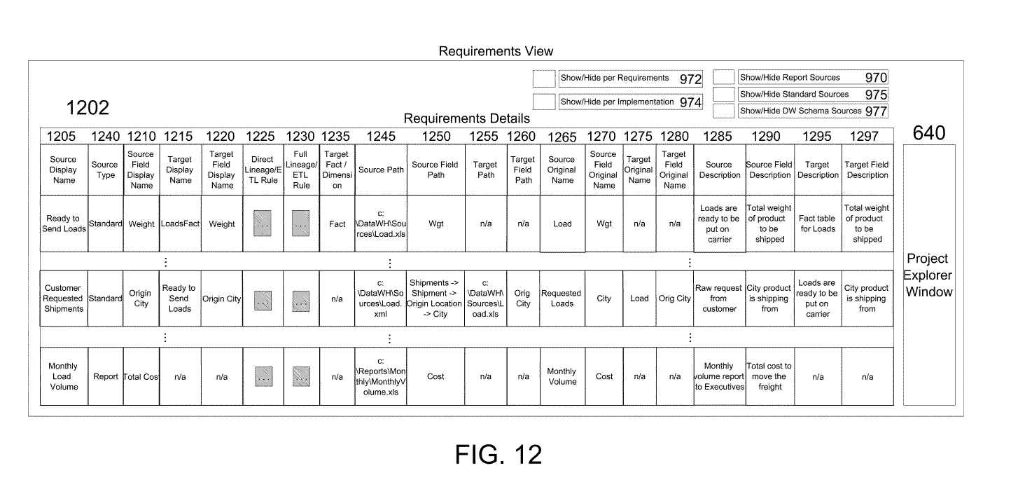

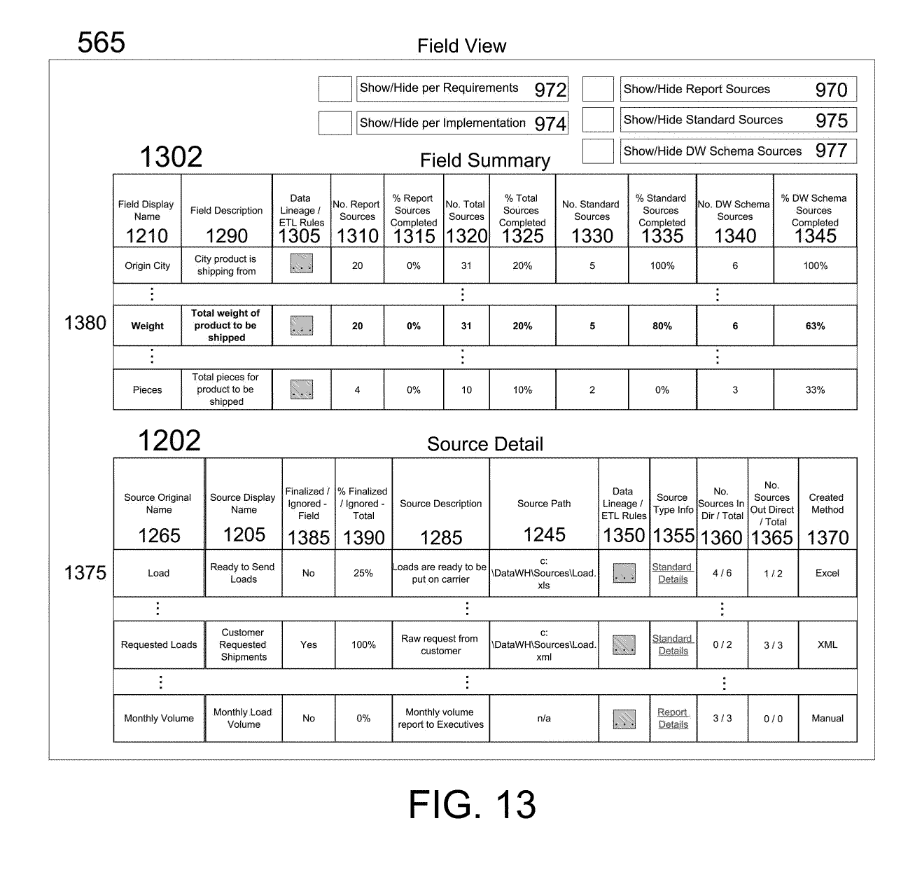

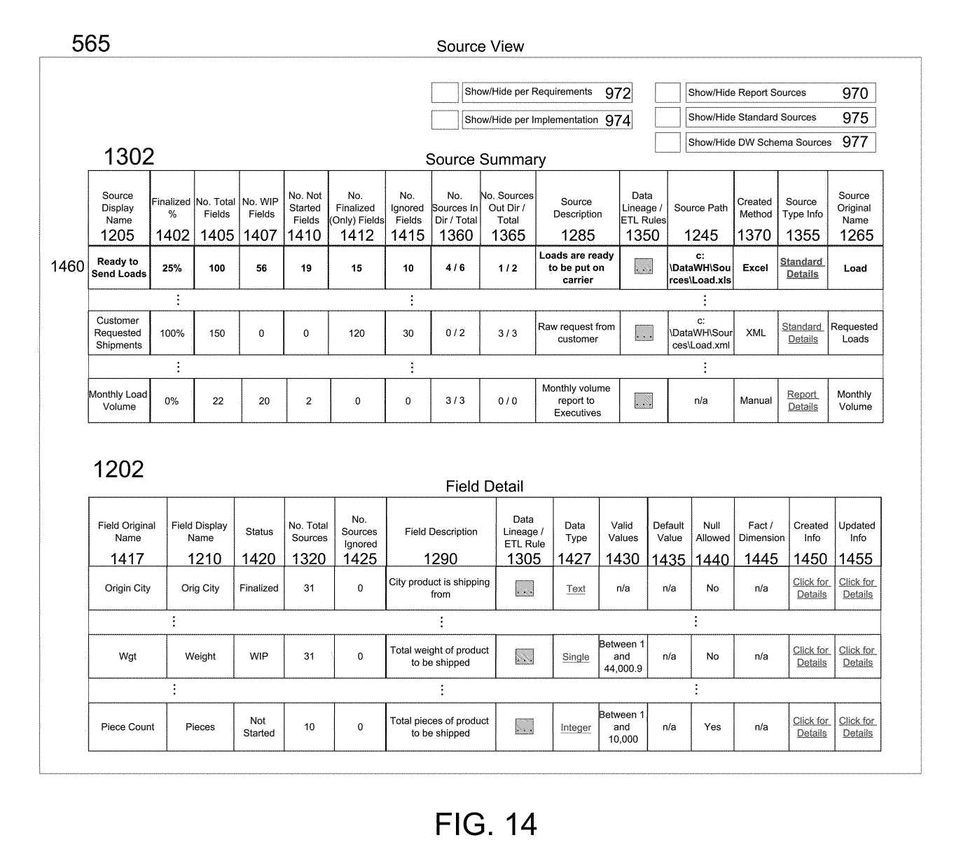

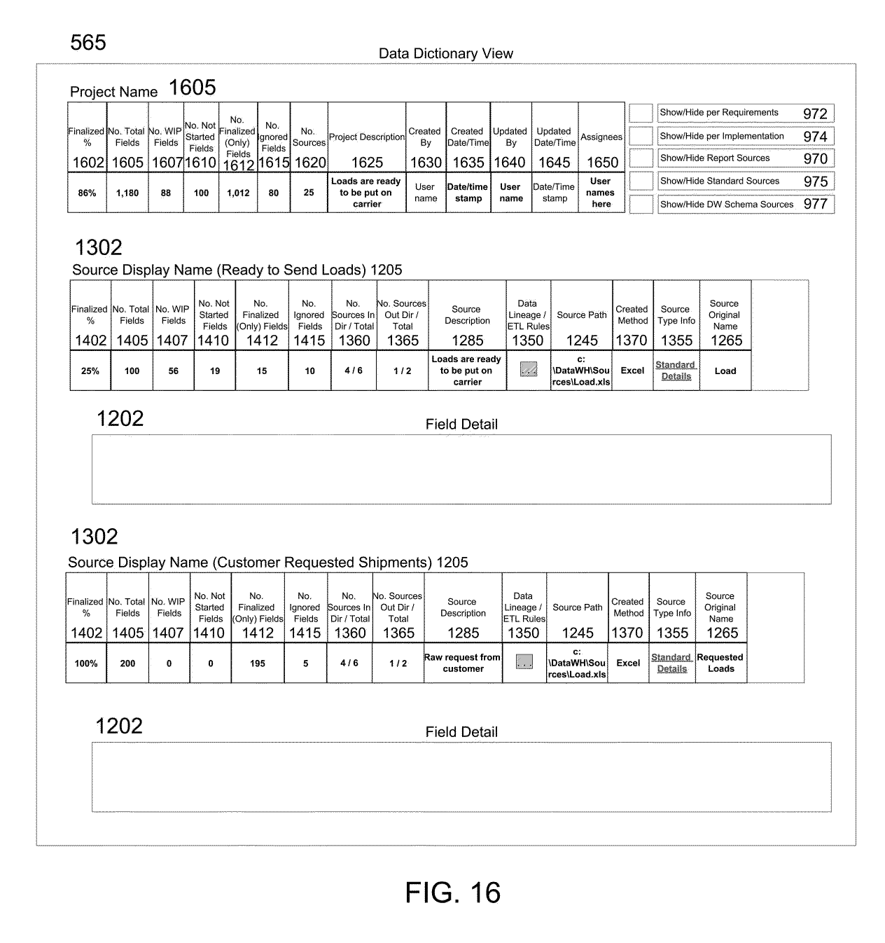

For the information received by the methods and systems 102 per the work performed by the user 505 in the source management work area 510 and source comparison work area 585, an example of resulting situations can be provided in various ways through the view management area 565. According to an example of the present invention, there are at least four views in this example: (1) the data mapping requirements themselves, (2) summary by field plus source details, (3) summary by source plus field details, and (4) data dictionary. In other examples, fewer or additional views with fewer or additional attributes could be provided. The details for these are provided per the explanations for FIG. 12, FIG. 13, FIG. 14, and FIG. 16, respectively. The methods and systems 102 can provide various other examples with different perspectives. One non-limiting example is information based on completion per the business requirements versus the implementation of the requirements.

In this example, at the minimum, the purpose of the administrative statistics area 562 can be to understand how the methods and systems 102 are being used (so that it can be constantly improved), to monitor the license usage, and to manage resource allocation. This area can consist of various statistics for the usage of the software usage guidance 520, 524, source comparison results received 585, 522, and overall methods and systems 102 usage. This area can also offer filtering capabilities to easily isolate any particular area of interest for review. These areas are further explained in FIGS. 15, 15A, 15B, 15C, and 15D.

In one example of how different users 505 can use the system, an analyst-type user 505 can interact heavily with the source management work area 510 and source comparison work area 585 and lightly with the other parts of the client screens (and less so with the administrative statistics area) while an administrative and/or lead user 505 can interact with the aforementioned areas along with the administrative statistics area 562. Additionally, in another example, an implementer user 505 of the methods' and systems' 102 requirements can utilize mostly the source management work area 510 and requirements view 1202.

FIG. 6 illustrates one example of a source management work area 510, which can be the main work area to receive the source-to-target mapping and ETL rules from the user 505. The source management work area 510 may be comprised of the following parts: physical mapping area 612, add/copy source 632, project explorer window 640, properties window 642, free-form search area 696, and notification area 698. In other examples, the source management work area 510 could be comprised of fewer or additional parts, such as a subset of the aforementioned parts.

The physical mapping area 612 can allow the user 505 to use the mouse (or finger on a touch screen display or other human interface device capable of providing appropriate functionality) to drag the mapping line 630, 641 from one source 602, 612 to another 607. More specifically, it is not the sources 602, 612, 607 that are being mapped to each other but the fields 610, 615, 620, 625, 635, 645, 646, 647 within those sources. This can be, for instance, a many-to-many relationship.

For example, Field3 615 can be mapped from Source1 602 to Field1 635 in Source5 607 by a line 641. The industry refers to this as source-to-target mapping. Since the methods and systems 102 do not limit the number of sources, the final target may be well beyond the second layer. Therefore, the examples for the methods and systems 102 refer to both sources and targets as sources. As in this case when there is a one-to-one field mapping, an extract transform load (ETL) rule may not be needed since this situation most often indicates that the data from the first field 615 should directly be placed in the receiving field 635.

When a rule is needed (even for a one-to-one field mapping situation), it can be specified in several ways, including, but not limited to: by double-clicking the line 641 joining the two fields, by going to the ‘Data Lineage/ETL Rule’ 692 property in the properties window 642 for any of the fields 615, 635 involved and clicking the build button 622 (as described later), by right-clicking over either of the fields 615, 635, or any combination thereof. This represents several examples; however, there are many other options that could be implemented and should be understood to be covered by this application. Some such examples include the choices being offered from a main menu, double-clicking an icon next to a field (which is used to indicate an ETL rule exists), applying the ETL Rule to only the target or the source, etc.

Another example is the mapping that can occur from both Field1 610 in Source1 602 and from FieldN 620 in Source2 612 to Field3 625 in Source5 607. This can establish that there are two fields each from a different source that may be required to properly populate the receiving Field3 625. In this case, it may be more typical to establish an ETL rule to alert the developer creating the actual ETL that more may be involved than just bringing one field of data to another as well as to specify the actual rules for doing so. Specifying the ETL rule can be accomplished in the same ways as previously indicated. As mentioned, the field mapping can be a many-to-many relationship, so the same ETL rule can cover one or more fields from one or more sources being mapped into one or more receiving fields in one or more sources (i.e., targets).

The dots 650 can indicate that (1) any number of layers of sources 602, 607, 612 can exist, (2) any number of fields (also per the label of ‘N’ in FieldN 620, 647) can exist within each source, and (3) any number of fields 610, 615, 620, 625, 635, 645, 646, 647 within any number of sources 602, 607, 612 can be mapped from or to any other number of fields 610, 615, 620, 625, 635, 645, 646, 647 within any number of sources 602, 607, 612. Another example of the implementation is a layer in between the sources and fields, that would allow a one-to-many relationship from sources to the in-between-layer and a one-to-many relationship from the in-between-layer to the fields.

According to an example of the present invention, the ability to quickly and easily set the rules can be a key component of the methods and systems 102. This can save time and effort, and the results can lead to the methods' and systems' 102 ability to properly utilize this information to continue to streamline the effort for the user 505 by providing, at the minimum, information status, reference, and validation functionality. This can be an advantage for a user whether or not he/she was originally involved in the effort.

Additionally, there can be many more important components from the source management work area 510 that aid in ease-of-use and providing the base information needed to realize the unique capabilities of the methods and systems 102. Among these can be the add/copy source option 632, project explorer window 640, properties window 642, free form search 696, and notification area 698.

The add/copy source option 632 can provide various ways to create sources. This can allow for creating a source by importing it from different types of files, by copying an existing source (and/or field), and/or by creating one (source and/or field) manually. The various types of files that could be imported include but are not limited to XML, Excel, csv, txt, and database tables from numerous types of databases 605. These are just examples, and it would be understood by one of ordinary skill in the art that many types of files not listed here are also contemplated for use with examples of the present invention. Further, in another example, the add/copy source option 632 can be used for different purposes, such as for requirements and/or for the implementation of those requirements, and the systems and methods 102 can present those in varying ways.

The add/copy source option 632 could be available through its own space in the source management work area 510 as depicted, through its own space in other work areas, through a right-click over each source (and field), and/or offered through a main menu. This shares various examples; however, there are several more that could be implemented and should be understood to be covered by this application. This includes, for example, the system identifying and alerting the user of unrecognized tables in a connected database as well as unrecognized files in a folder.

As an example, the project explorer window 640 can be used to easily identify the objects involved in the project, including their hierarchy, and to show/hide 653 the sources 688, 602, 685, 607, 612 and fields 691, 610, 692, 646, 693, 647, 615, 625, 635, 645, 620 from those that are on the screen. Typical expand/collapse 693 functionality can provide the show/hide ability 653 (including all objects within a project 687). This can allow the user 505 to quickly and easily identify and focus on the sources and fields of interest rather than showing everything and requiring the user 505 to sift through objects that are not on his/her immediate radar of interest.

The selection of displayed/hidden sources and fields can work in conjunction with or independently from the filtering by status category offered in the progress status and filtering guidance 515 work area as previously explained and as explained later herein.

Additionally, the selection of displayed/hidden sources and fields can be utilized to identify which objects should be exported or printed. In preferred examples, the ability to export or print is offered through a main menu, a right click over the source management work area 510, a right click over all other work areas, and other examples that may or may not be provided in the descriptions of the methods and systems 102 which would be understood by one of ordinary skill in the art are contemplated for use with examples of the present invention.

The properties window 642 can show various attributes of the source or field with focus per the project explorer window 640 and the physical mapping area 612 (all three areas, properties window 642, project explorer window 640, and the physical mapping area 612, can be in sync with each other). In FIG. 6, some ‘properties’ shown can be the actual properties while others can be property groupings. This is for the purpose of explanation since the specific properties that can be included in the property groupings can vary. For example, the ‘Data Lineage/ETL Rule’ 692, ‘Finalized’ 660, ‘Ignored’ 665, and ‘Source Type’ 697 can be individual properties while ‘Source Type Info’ 670, ‘Data Profiling Info’ 672, ‘Create/Update Info’ 680, and ‘SQL Create Info’ 675 can be property groupings. These are non-limiting examples such that other implementations can be utilized. For example, the ‘Finalized’ and ‘Ignored’ properties can become a group while current groups may be split into one or more other groups and/or individual properties, and the methods and systems 102 can have more than one set of similar properties that may be used to for similar or different purposes. All variations should be considered to be contemplated for use with examples of the present invention. The names of the properties are also subject to change and these variations should also be considered to be contemplated for use with examples of the present invention. One of ordinary skill in the art would appreciate that there are numerous such variations, and all variations are contemplated for use with examples of the present invention.

The ‘Data Lineage/ETL Rule’ 692 may be set by the user 505 in the physical mapping area 612, the comparison work area 585, or the comparison functionality of the system per FIG. 8, FIG. 8A, FIG. 8B, FIG. 8C, and FIG. 8D. Its initial purpose can be to provide the ETL rules to the implementer of the data warehouse and/or field mapping effort (The implementer can be an internal or external development and/or an external vendor); however, there can be several other uses. First, it can also be used during the validation process to troubleshoot where the data in the target does not appear to be correct and/or confirm that it is. Next, it can be used as the metadata to identify where changes in the future may affect particular sources and/or fields. Third, it can be utilized as input for the data dictionary. Finally, its existence or non-existence can be used to determine the status of that field and eventually the status of the source. This property can be used to provide an attribute describing instructions for managing the data for this property's field or fields it is referencing. The name of the property can be irrelevant. One of ordinary skill in the art would appreciate that there are numerous such variations, and all such variations are contemplated for use with the examples in the present invention. This includes, but is not limited to, the case where the data is first loaded and then transformed, i.e., ELT (extract-load-transform). One of ordinary skill in the art knows this can be the process for managing Big Data.

As an exemplary illustration, if there is a rule in the ‘Data Lineage/ETL Rule’ 692 property for a field and/or a line 630 to it, then the status of that field can become ‘Work in Progress (WIP)’. If not, the status can remain as ‘Not Started’. When all of the fields of a source have the status ‘Not Started’, the source can be given the same status. The status categories (discussed in later sections herein) can be provided in the progress status and filtering guidance area 515 for filtering and a quick understanding of the overall progress.

The user can set the ‘Finalized’ property 660 to ‘on’ (checked) to indicate that all decisions on the field have been made. If the user checked the ‘Finalized’ property 660 to ‘on’ but there is no line 630 to the field and no ETL Rule 692 exists, the methods and systems 102 can prompt the user to see if he/she meant to set that field to ‘Ignored’ (see next paragraph). This is because the lack of a line 630 and ETL rule 692 can indicate there are no instructions regarding the field. The user can choose to allow it to be ‘Finalized’ (against the methods' and systems' 102 recommendations), choose to set the field to ‘Ignored’ instead, or choose to cancel and leave the status as Not Started′.

If the user unchecks the ‘Finalized’ property 660, the methods and systems 102 can set the status of the field to Not Started′ if no instructions are present (no line 630 and no ETL Rule 692) or to WIP (Work in Progress) if instructions are present. When all of the fields of a source have the status ‘Finalized’ (or ‘Ignored’—see next paragraph), the source can be given the same status.

Similar to the ‘Finalized’ property 660 is the ‘Ignored’ property 665. The ‘Ignored’ property 665 can be under the user's control and its purpose can be to let the methods and systems 102 know (and remind the user 505) that the field is not of any interest or consequence to the requirements effort, yet that it is accounted for. When all of the fields of a source have the status ‘Ignored’, the source can be given the same status. Another example situation can be that when all of the fields of a source have either the ‘Finalized’ or ‘Ignored’ status, the status of the source can be set to ‘Finalized’. As with all statuses, the fields can be filtered in and out for display in the physical mapping area 612 by the progress status and filtering guidance area 515 (see FIG. 9 explanation); however, for the ‘Ignored’ status, there can also be a global setting that always does or does not filter out the ‘Ignored’ status.

Further, there can be one or more similar, but separate, fields that the systems and methods 102 can manage as a result of the presence or absence of an existing source in a database, of existing amounts or types of data, etc. As an example, the systems and methods 102 can utilize information to provide a different set of progress statistics.

The ‘Source Type’ property 697 can identify what type of source the methods and systems 102 have received for that object (per the user's input). The options may include: Report, Data Warehouse (DW) Schema, Standard, or user defined. The ‘Report’ type can indicate that it is a deliverable to an end user that is for general reporting or analytics. The ‘DW Schema’ type can indicate it is a table or entity that is a direct contributor to the database structure of the Data Warehouse itself. Per industry terms, this can be the target in the truest sense of the word. The ‘Standard’ source type can be at any level of the project—first (raw or original source), intermediate, final, etc—but is typically not part of the final DW schema and is typically not a report. Other source types can be received by the methods and systems as defined by the user, including whether or not this type can be utilized in filters (see FIG. 9). Example uses of these are just as labels, groupings, filtering, visual distinction, and/or other not specially mentioned functionality, all of which should be considered to be contemplated for use with examples of the present invention.

The ‘Source Type Info’ 670 can be a property grouping that includes various properties for the source type 697 that was specified. For the ‘DW Schema’ source type, these properties could include specifics related to star schema information, such as a dimension/fact indicator; if dimension, which dimension is it a part of; if fact, which dimension is it associated to; etc. For the ‘Report’ source type, the properties may include: Report Name, Frequency, Requestor, etc. For the ‘Standard’ source type, there may or may not be any additional properties. In all cases, the various attributes in this grouping can generally be separate properties in the Properties Window 642, and they can be user-defined for both a system-provided and user-defined source type.

At this time, it is important to expand upon the distinctiveness of the ‘Report’ source type. According to certain examples of the present invention, the ‘Report’ source type can be useful in several ways, including, but not limited to: prioritization, coverage, and validation. For prioritization, in a preferred example, before any mapping requirements could be considered, general data warehousing and business intelligence requirements must be determined. As part of that effort, it is important to understand what reports are currently being provided and used. In one example, by importing existing reports, the methods and systems 102 can determine the frequency of the fields used, by their presence and/or population, per data profiling potentially (This can actually be performed for all types of sources, report or not.). The view management area 565 can quickly show the user these results, and therefore in most cases which fields would have the highest priority for the data warehouse and/or field mapping effort. This view is further discussed per FIG. 13 although the explanations for FIG. 12 and FIG. 14 may also be helpful.

For coverage, once the data warehouse (and/or field mapping) mapping requirements have been set, the source comparison functionality 585, 522 of the methods and systems 102 can be utilized to systematically compare the report sources to identify which fields have and have not been covered by other types of sources. The user can also manually compare all types of sources. The results may then be viewed in the view management area 565 to determine the coverage accomplished or lacking Additionally, the progress status and filtering guidance area 515 can be used for report-only sources in various statuses (i.e., that are not ‘Finalized’) to quickly refer to the fields and sources of interest. In certain examples, this can be performed for all types of sources, whether there is a report or not. With this approach, the methods and systems 102 can easily present the user 505 with the data lineage to troubleshoot or just review any field in question.

Finally, for validation, the methods and systems 102 offer the user 505 a similar comparison approach as previously defined but the comparison may be made with the already imported report sources versus the created reports from the new data warehouse (and/or field mapping effort). The created reports can result from a connection to a database or via imported files reflecting the tables in a database or other file types. The results may then be reviewed in the view management area 565 to determine the coverage accomplished or lacking.

The ‘Data Profiling Info’ property 672 can be a property grouping as well. The various attributes within this grouping may be separate properties in the Property Window 642. In preferred examples, at the minimum, when a field is highlighted (such that a field's properties are shown in the Properties Window 642), examples include, but are not limited to: data type, nulls allowed, default value, valid values, min value, max value, etc. When a source is highlighted (such that a source's properties are shown in the Properties Window 642), the data profiling results of the source can be displayed through this property, including the examples of ‘Source Type’ and ‘Source Type Info’ groupings, etc.

To expand on the properties, these can be incorporated into the learned comparison per FIG. 8, FIG. 8A, FIG. 8B, FIG. 8C, and FIG. 8D for decisions/recommendations based on the data profile of the potentially matching fields. Data profiling can review the columns of data for patterns, such as the frequency of values within a field, identifying unique values within fields (for numeric fields, median, average, min, max, etc), dependencies within a table/file (i.e., postal or zip based on country), and cross-table dependencies (i.e., % of customer values in various tables to identify overlapping, etc). When no field matching exists, the data profiling can be used to still populate various properties of the individual fields, saving the user 505 time. As always, the methods and systems 102 can capture and receive any changes made by the user 505, as the user must maintain full control over the final decisions. Further, the source comparison learning algorithm 522 can update its knowledge as the methods and systems 102 receive any overrides from the user 505.

The ‘Create/Update Info’ property 680 can be another property grouping. The various attributes within this grouping may be separate properties in the Properties Window 642, including for example: Created By, Created Date, Updated By, Updated Date, and Responsible Party. In preferred examples, the Responsible Party defaults to the Created By. In other examples, the Responsible Party may be another person, such as a first person writing up what a second person requested. The ‘Responsible Party’ could be the go-to person should questions arise about the field. In a preferred example, these attributes can be important to the methods and systems 102 given the innate ability of them to refer to the metadata about the requirements. For example, if an unknown field suddenly appears in the data warehouse to one user 505, the methods and systems 102 could receive a search 696 (see later in this section for more information) or filter 515 (see FIG. 9 for more information) request by the user 505 for that field and then review its properties to immediately know who is familiar with that field.

The ‘SQL Create Info’ property 675 can be a property grouping, too. A couple of typical properties under this grouping may include: Create Target SQL and Create ETL SQL. For the former, the methods and systems 102 could receive and act upon the request to create the SQL syntax to create the selected target sources for various types of databases. This can be per other stand-alone properties, properties of property groupings defined, and/or normal database properties that could be included in the example but may not explicitly be referenced above. For the latter, the methods and systems 102 could receive and act upon the request to create the SQL syntax per the ‘Data Lineage/ETL Rule’ 692 and mapping lines 630. Other examples include providing this functionality both through the main menu and by right clicking in the source management work area 510. These are a merely a few examples and one of ordinary skill in the art would appreciate that there are numerous other examples that could be utilized and the present invention are contemplated for use with any such example.

The free form search box area 696 can allow the user to enter any text that can be used for searching within the entire project. The results can be highlighted and/or provided in a pop up window or by other means for ease-of-identification and navigation. Other examples can exist that may or may not be explicitly stated but that are included in this application.

In one example, the notification area 698 can be used in conjunction with the administrative statistics 562, progress status and filtering guidance 515, and software usage guidance 520 areas. The methods and systems 102 can select the results from (and potentially inputs to) these areas and the results from the learning algorithms to show the ideal (most critical) information in the notification area 698. Many other uses of the notification area 698 may or may not be explicitly stated throughout this document; however, one of ordinary skill in the art would appreciate that there are numerous other uses for the notification area, and examples of the present invention are contemplated for use with any such usage of the notification area.

FIG. 7 presents an example of the Source Comparison work area. The source comparison work area 585 allows the comparison of at least two different sources. Known sources are presented in the source drop down boxes 710, 715. When the source from the drop down 710 is selected, the fields 720, 725, 730, 735, 740 from that source can be populated below it. Similarly, when the source from the drop down 715 is selected, the fields 745, 750, 755, 760, 765 from that source can be populated below it. Sources can also be introduced for comparison through the add/copy source 632 functionality directly from the source comparison work area 585 or the physical mapping area 612. If the source is introduced from the physical mapping area 612, the methods and systems 102 can move to the source comparison work area 585 upon request. Among other examples, the methods and systems 102 can invoke the comparison learning algorithm 522 when the second source is selected or introduced in the source comparison work area 585, when the click of the Compare button 702 is received, and per other examples not explicitly stated but understood to be covered by this application (such as through a main menu selection). As normal, the methods and systems 102 can continue to provide the use of the project explorer window 640 and properties window 642.

The results of the source comparison learning algorithm 522 can be provided as proposals/suggestions with lines 770, 775, 780. FIGS. 8, 8A, 8B, 8C, and 8D explain how these conclusions were reached. In the meantime, the methods and systems 102 can wait for and receive the responses for the proposals. The responses (from the user 505) may be, for example, but not limited to: fully approved, conditionally approved, and no match.

‘Fully Approved’ can indicate that any time the field names are identified the match should always be assigned as a final decision. ‘Conditionally Approved’ can mean the methods and systems 102 should continue to propose the match, but not as a final decision. Utilizing only the field names to identify the match is one example. Others include the consideration of data types and data values (and potentially other attributes) in addition to field names. An example of the result of these considerations is that a match can be assigned ‘Fully Approved’ based on data types and data values as well as field names while it could be ‘Conditionally Approved’ when only the field names match. One of ordinary skill in the art would appreciate that there are numerous results that could flow from the considerations, and examples of the present invention are contemplated for use with any appropriate results. ‘No Match’ can designate that the methods and systems 102 have already received a decision that these fields do not match. One example of how the decisions are received can be by the user 505 right-clicking over the lines 770, 775, 780 and choosing an option from which he/she selects. One of ordinary skill in the art would appreciate that there are numerous ways in which decisions could be received, and examples of the present invention are contemplated for use with any method for receiving decisions.

At this point, clarification between ‘proposal’ and ‘suggestion’ is helpful. A ‘suggestion’ can be a match that has not been previously identified through the methods and systems 102 and/or has not previously received a match response decision (Later in the document, this is referred to as a ‘match status’ rather than ‘match response’ decision.). A ‘proposal’ can be a match that has previously been identified with a response received, and it is considering the most recent assignment received for the match. One example is to only consider matching rules within a single project within a single client. It is also included in this documentation to cover settings that would allow across-project, across-client, and across-vendor matching rules.

The lines 770, 775, 780 may be differentiated based on the assignments described above. As default behavior, the lines 770, 775, 780 can be green for fully approved, yellow for conditionally approved, and red for suggested. The lines would not exist for two situations: the no match assignment and if the methods and systems 102 could not determine a suggestion. In one example, the method of differentiation (i.e., color, highlighting, line type, etc) is based on the received information provided by the user 505 through the configuration settings. One of ordinary skill in the art would appreciate that there are numerous ways to provide differentiation, and examples of the present invention are contemplated for use with any appropriate method for providing differentiation.

A feasible example for line presentation can be the line 770 from Orig City 720 in Source1 710 to Orig City 745 in Source5 715. Using the assumption that it was a previously suggested match that received the ‘Fully Approved’ status, the line 770 can be green. Another feasible example can be the line 775 from Orig State 725 from Source 1710 to Orig St 750 from Source5 715. Assuming this match received the ‘Conditionally Approved’ status, this line 775 can be yellow. Finally, the source comparison learning algorithm 522 derived the potential match from Orig Postal Code 730 from Source1710 to Orig Zip 755 from Source5 715. Since this match hasn't yet been presented and no match status has been previously received, the line 780 can be red. Since the learning algorithm was unable to determine any further matches for fields 740, 735 from Source1 710 to fields 765, 760 from Source5 715, no lines exist for these fields.

Since the comparison area 585 may manage only two sources at a time, whenever there is field mapping and/or an ETL rule that involves a third or more sources, one example for viewing the combined information is that the line can be displayed with a filled in circle on it. The methods and systems 102 can allow the information to be viewed by clicking on the line's filled in circle, by the previously described manners for reaching the ‘Data Lineage/ETL Rule’ property 692 details, and by other examples that may or may not have been explicitly stated but are understood to be covered by this application. Further, in preferred examples, more than one match may need to be presented. The methods and systems 102 can receive the decision for each match suggestion.

Once the click of the ‘Compare’ button 702 is received, the sources selected can become read-only in the physical mapping area 512 of the source management work area 510, and the methods and systems 102 can retain the state of these sources. In one example, matches and match statuses are received upon the click of the ‘Accept’ button 722. The Accept button 722 can then retain all mapping and properties for the selected sources. The resulting updates can be reflected in the physical mapping area 612 of the source management work area 510, and the selected sources will again be editable in that area. A different example can be that the Source Comparison work area 585 overlays on top of the physical mapping area 512 so that the user 505 does not have access to the selected or other sources while the source comparison functionality is being utilized. In this example, the ‘Accept’ button is not needed. Finally, in one example, the button for the System Integration menu 714 can be presented or highlighted (or otherwise emphasized) under the known or learned conditions of the methods and systems 102 to allow data requirement mapping rules to be received for data that can be merged from two or more sources, versus being mapped from one source to the other. These concepts are further explained in FIGS. 8, 8A, 8B, 8C, and 8D.

FIGS. 8, 8A, 8B, 8C, and 8D show one example of computer implemented methods and processes of the present invention again referred to as the “source comparison learning algorithm” 522. This may also be referred to as “comparison functionality” or “learning algorithm”. The source comparison learning algorithm may be utilized for the source comparison functionality of the system. This source comparison learning algorithm addresses one example of how the comparison occurs between at least two sources and for the use of system migrations. FIG. 8 provides an example of the overview for the example presented in FIG. 8A to 8D.

FIG. 8 starts with FIG. 8A, which can then flow to FIG. 8B and on to FIG. 8C. A different flow from FIG. 8A is on to FIG. 8D. Beginning with the first example flow, FIG. 8 shows that FIG. 8A can apply to establishing the match proposals/suggestions 818. FIG. 8B illustrates an exemplary approach to receiving the decisions on the proposals/suggestions 821. After receiving the decisions, FIG. 8C can offer the System Integration functionality 886. As an example of one alternate flow, FIG. 8A can go into FIG. 8D, where received matches can occur per manual creation and are managed accordingly 883.

Beginning with FIG. 8A and moving to the others as appropriate, the comparison functionality 522 can be invoked under two conditions in this example: through receiving a request for comparing sources per the ‘Compare’ button 702 and through receiving a request for a new source though the add/copy functionality 632.

Next, the fields in the selected sources can be used to identify potential matching fields and/or ETL rules per existing matching rules. This may be accomplished through the captured and received results of previously established matched fields, ETL rules, synonyms according to current or previous source comparison learning algorithm proposals and decisions, a phonetic, a metaphone or double-metaphone algorithm, a derivative of these or other algorithms, and/or other internally developed algorithms 815, 823, or any combination thereof. One of ordinary skill in the art would appreciate that there are numerous types of source comparison algorithms that could be utilized, and examples of the present invention are contemplated for use with any appropriate source comparison algorithm.

Then, it can be determined if a decision is needed 805. If this decision was just received on the field(s) at hand, the learning algorithm is completed 830. If this is the beginning of the process for the field(s) at hand, the next step can be to determine whether or not matches for one or more fields were found 820. If no match is found or if the learning algorithm determines that an identified match has a match status of ‘no match’, then no line 630, 641, 770, 775, 780 between the fields is created 825. Whether or not the learning algorithm presented a suggestion/proposal, the methods and systems 102 may receive a user 505 decision per his/her manual mapping. This example will be discussed later in this section per FIG. 8D.

In some examples, the previous match status can be considered in the final proposal decision and can be presented. As a result, if the match status is ‘Fully Approved’ 835, the source comparison learning algorithm will set the joining line 770 according to the received specification, i.e., green as default or the user-specified indicator 850. If the selection of ‘Fully Approved’ is not received, the learning algorithm checks to see if the selection of ‘Conditionally Approved’ is received. If the match status is ‘Conditionally Approved’ 840, the source comparison learning algorithm will set the joining line 775 according to the received specification, i.e., yellow as default or the user-specified indicator 855. If a new match is determined, the source comparison learning algorithm can set the match status to ‘Suggestion’ and the joining line 780 according to the received specification, i.e., red as default or the user-specified indicator 845. The methods and systems 102 can present these matches and match status indicators 860. As hinted, through various configuration settings the methods and systems 102 may have received a user-decision to change the type of indicator that is displayed for the suggestions/proposals (e.g., the color, such as green 850, yellow 855, and red 845, or the line type, or highlighting, etc).

At this point, continuing to FIG. 8B, the methods and systems 102 may receive the user's result of making match status changes 865, including any criteria that needs to be involved in the match status, such as which of these is the match based on: field name and data type and/or data values 895. As also noted later, these results are incorporated into the source comparison learning algorithm 895, 885, 890, 875, 815.

If the result is a change to the match status, the methods and systems 102 can set the match status according to the change 880. Next, whether or not the match status result was a change, the methods and systems 102 can receive the matches that are accepted 870. If there are proposed/suggested matches that are not accepted, the methods and systems 102 can provide that response to the learning algorithm, and the learning algorithm tracks the proposed/suggested matches as not accepted 875, 815 (on FIG. 8A).

If the methods and systems 102 receive at least one accepted match, the methods and systems 102 can provide that response to the learning algorithm, and the learning algorithm saves these field mapping matches and match statuses for this project 885 and for future use 890, 815 (on FIG. 8A). From there, the received results from user-assignments can also be tracked to understand and analyze behavior and to use in future suggestions/proposals 875, 815, 823 (on FIG. 8A).

In preferred examples, there can be two simultaneous paths at this point. One path can take us back to FIG. 8A: the results can be captured for future use 815, 823 (as just mentioned), the decision(s) can be finished 805, and the learning algorithm can be concluded 830. The other path leads us onto FIG. 8C. This example can be the option of the presentation of the System Integration menu 714, 807, 812. The presentation of the System Integration menu can depend on the software usage guidance system 862. An example is if a certain percentage of fields are mapped directly one-to-one in the source comparison, indicating these sources may be part of a System Integration rather than regular requirements field mapping to a potentially new system, this button can become more prominent. Other learning in the software usage guidance system can occur to identify this potential situation (See FIG. 11 and its description for more information.) 862. If the software usage guidance systems and other parts of the methods and systems 102 have determined it is not necessary to highlight the Systems Integration Menu 714, the methods and systems 102 can return back to the learning algorithm 815 (on FIG. 8A) and from there can decide if the previously described processes continue or stop (i.e., decision is not needed 805 and the learning algorithm is concluded 830 or the previously described other paths are followed) although the methods and systems 102 can offer the Systems Integration Menu 714 to the user 505 at any time.

An example flow to this point is that the methods and system 102 have already received the mapping from Source1 710 to Source5 715, which have come from different systems in one example. The System Integration menu 714 can offer options to utilize these data requirement mapping rules effectively and efficiently to create the data requirement mapping rules for merging these two or more Sources into one or more new or existing Sources. Upon the methods and systems 102 receiving the request to display the System Integration Menu 807, the System Integration Menu is displayed and two decisions can be requested 812. These key decisions can be: (1) the structure of the new resulting merge Source, in one example, called Source6, and (2) what mapping to retain into this source, Source6 812. The systems and methods 102 receive the selection for the structure of the new resulting merge Source, Source6, so Source6 is created as a copy from Source1 710 and/or Source5 715, or from a new Source 832. Further, the methods and systems 102 receive the decision to apply the mapping, ETL rules, other properties, and/or nothing 847 from Source1 710 to Source6, Source5 715 to Source6, or none 832. The methods and systems 102 then display the Source Management work area 842.

If the request for the System Integration menu was not received, the methods and system 102 can send the user 505 to determine potential matches 815 on FIG. 8A, and/or, the Source Comparison Work Area 585 can be displayed until the methods and systems 102 receive a request to navigate elsewhere in the methods and systems 102.

Referring now to the step where no line is created by the learning algorithm 825 leads us to FIG. 8D and the presentation of an example covering the receipt of user-created mappings 867. The methods and systems 102 can receive a mapping requirement through a direct line and/or per an ETL rule whether or not the source comparison learning algorithm suggested or proposed one 867, 630, 641, 692. Further, one example is that the match can be created per any combination of field name, data type, and/or data values and with any match status 895, as previously described. If the methods and systems 102 do not receive a line or ETL rule for particular fields, the source comparison learning algorithm can be concluded for those fields 830.

When the methods and systems 102 receive a direct line and/or ETL rule 867 for at least one set of fields, two potential paths can take place per one example of the present invention. First, the received match and match status can be captured, and the match status can be set to ‘Conditionally Approved’ (as previously defined) if not specified 872. The field names can be compared to the various algorithms in place to determine if they would have been matched accordingly 877. If this comparison shows that the fields would have been matched 882, no specialized rule needs to be captured 887, and the learning algorithm continues with saving the selected field mapping 885 (on FIG. 8B), as previously described. If the comparison shows the fields would not have matched per the various algorithms in place 882, the specialized rule can be set 892, and the steps can continue with the saving of the selected field mapping 885 (on FIG. 8B), as previously discussed. Second, synonyms can be identified and captured for the field names that are matched, and the matches for the synonyms can be set to ‘Conditionally Approved’ 897. Next, the steps continue with the saving of the selected field mapping 885 (on FIG. 8B) for the synonyms, as previously noted.

FIG. 9 shows one example of the progress status and filtering guidance area 515. This area can provide a snapshot of the progress as well as a mechanism which can allow the user 505 to focus on the sources and fields of interest by status category. The status categories can include WIP (work in progress) 905, Not Started 910, Finalized 915, Ignored 920, and Total 925. As previously described, WIP 905 and Not Started 910 can be determined by the system based on when there is a line 630 or ETL Rule 692 for the field, and the methods and systems 102 receive the user's 505 setting of Finalized 915, 660 or Ignored 920, 665.

As a reminder, one of the functions of the project explorer window 640 can be to provide the user 505 the opportunity to show/hide sources and fields in the physical mapping area 612. When sources/fields are checked on, to show, they can also be considered ‘selected’ for the purpose of the progress and filtering guidance work area 515. In one example, the progress and filtering guidance work area 515 can display counts and percentages for the selected sources/fields and for all of them. This includes information for the summed totals 925.

The count of the fields per those sources and fields that are selected can be shown in the boxes in the column ‘Selected No’ 930. The corresponding percentage can be found in the column ‘Selected %’ 935. Similarly, the count for all of the fields, whether or not selected, can be shown in the column ‘Overall No’ 940, and the corresponding percentage can be provided in the column ‘Overall %’ 945. The number of selected sources can be in the column ‘Selected Sources No’ 960, and the total number of sources, selected or not, can be displayed in the column ‘Overall Sources No’ 965.

Aside from the ability to quickly determine the status of the project, one example of the power of the progress and filtering guidance work area 515 can be to present information which is focused specifically on the work of interest for the user 505, eliminating any ‘noise’. Some examples of ‘noise’ can be having to spend time navigating through sources/fields that may already be addressed and/or those that the user 505 is not ready to address. Leaving sources/fields that are not of current interest to the user 505 in the middle of the work areas can detract him/her from being efficient in his/her effort.

In various examples, this ‘clean’ work area can be accomplished with filters for the categories of interest and types of sources in at least three ways. First, each status category 905, 910, 915, 920, 925 can offer the ability to show or hide the affected sources and fields within that status category selected per the project explorer window 640, 950. Secondly, the project status and filtering guidance area 515 can respond to selections to show or hide all sources and fields within the particular status category, regardless of the selected sources and fields per the project explorer window 640, 955. Finally, the project status and filtering guidance area 515 can independently include filters to show or hide the sources and fields by the type of source: Report Sources 970, Standard Sources 975, and DW (Data Warehouse) Schema Sources 977 (or user-defined type as previously mentioned). This example illustrates the currently provided source types; however, other applicable examples, such as the user-defined type, and others not specified can be utilized with examples of the present invention. One of ordinary skill in the art would appreciate that there are numerous source types that could be utilized with examples of the present invention, and examples of the present invention are contemplated for use with any such source type.

Show/Hide per Requirements 972 and Show/Hide per Implementation 974 can show or hide the progress information based on the systems and methods 102 consideration of the statuses of sources and fields per requirements established and/or the implementation of those requirements, respectively. The systems and methods 102 can utilize its information for one or more sets of all of these key statistics.

Further, various other examples can be utilized in displaying the statistics, such as on different parts of the screen and can include configuration and/or default options of what to show and under what circumstances. All variations, whether or not specifically described are considered to be contemplated for use with examples of the present invention. One of ordinary skill in the art would appreciate that there are numerous variations that could be utilized with examples of the present invention, and examples of the present invention are contemplated for use with any such variation.

Additionally, the methods and systems 102 can include various properties for users 505, such as for projects, sources, in-between sources and fields, fields, applicable versions and/or layers of the fields, sources, projects, and other objects that may or may not be explicitly stated in this document. Examples can be progress properties, such as status updates for which objects are being worked on or not yet started, as utilized by the implementer. These properties can then be included as part of the Progress Status and Filtering Guidance 515. One of ordinary skill in the art would appreciate that there are numerous properties that could be utilized with examples of the present invention, and examples of the present invention are contemplated for use with any such property.

FIG. 10 shows one example of the software usage guidance area 520. One purpose of this area can be to alleviate a layer of complexity, i.e., that of learning new software (per examples of the methods and systems 102 in accordance with examples of the present invention), to the already time-consuming, tedious, resource intensive process of creating data mapping requirements (as well as source and field prioritization, validation, etc). One example to accomplish this can be to display alerts about the methods and systems 102 to the user 505 for key situations at key points. This can allow focus to be on the requirements while helpful methods and systems 102 functionality can be introduced only when necessary and pertinent.

One example of the software usage guidance results area 520 can be that triggers 1040 are used to identify when to provide background information 1045 and the tip itself 1050. Also, the guidance is presented according to the freshness of the tip 1005, 1010, 1015. In FIG. 10, the trigger utilized could be the first time 20% or 20 (whichever is less) of the fields of a new source have a line or have an ETL rule 1040. The trigger is shown in FIG. 10; however, it may or may not be presented. The background information 1045 can explain why the tip 1050 is being presented (key situation), and the tip 1050 is the key point of interest. For example, in FIG. 10, the background information is that “20 of your x fields in Source y [or 20% of your fields in Source y] are work in progress, meaning they have a line (mapping) from another field going to them and/or they have some ETL associated with them.” 1045. ‘x’ can indicate the total number of fields in the source, generically referenced as ‘y’ in this example. The tip itself can be “You can use the filter, now highlighted in green, to easily review these or to say your rules are finished by setting their ‘Finalized’ property to “true”. Click here to learn how to do this.” 1050. By clicking ‘here’, per the example above, the methods and systems 102 could provide more detailed information, instructions, and/or a demo to elaborate on the ‘Finalized’ property, or any other topic per other exemplary situations.

This is one example, and there are an unlimited number of others, all of which are understood to be contemplated for use with examples of the present invention. Other examples can include various types of triggers based on various types of data and functionality (i.e., numbers or percentages of fields and/or sources reaching any other status, time between progress, software usage guidance area not accessed within certain time frame, etc). The background information and the tip can use any wording, presentation (i.e., colors, line styles, highlighting, enlargement, etc), and/or demo, to provide the corresponding guidance needed (i.e., additional statuses available, general encouragement, encouragement for how others move the project forward faster, awareness of the source comparison functionality, etc). Additional examples can utilize customizable/configurable settings received by the methods and systems 102 for the actual trigger point, the background information, and the tip itself.

Once each non-limiting example of the guidance is created, it can be placed in the software usage guidance area 520. For instance, newer tips being placed at the top 1005, older recent ones in the middle 1010, and the oldest ones at the bottom 1015. Every current 1005 or recent tip 1010 can offer the option to View 1020, Archive 1025, or Delete 1030 the guidance. One of ordinary skill in the art would appreciate that there are various ways the guidance could be organized and displayed, and examples of the present invention are contemplated for use with any organization and display style for such guidance.

The View 1020 option can show the background info 1045 and the tip 1050 (and possibly the trigger 1040). The archive 1025 option can send the tip to the oldest section 1015, and the Delete 1030 option can delete the tip from the user's view (although it can be maintained in the database). The options for the oldest tips 1015 are only View 1020 and Delete 1030. The methods and systems 102 store and utilize the number of current 1005, recent 1010, and oldest 1015 tips that can be displayed. This is managed according to the software usage guidance learning algorithm described next per FIG. 11 and receiving the settings per the methods and systems 102. FIG. 11 also points out that another example for displaying the software usage guidance results can be in the notification area 698. One of ordinary skill in the art would appreciate that there are various ways the software usage guidance results could be organized and displayed, and examples of the present invention are contemplated for use with any organization and display style for such software usage guidance results.

FIG. 11 shows one example of computer implemented methods and processes of the present invention again referred to as the “software usage guidance learning algorithm” (or “software guidance learning algorithm” or “software guidance functionality” or “learning algorithm”, the latter for this section only as an additional “learning algorithm” was addressed earlier) 524 which is utilized for populating the software usage guidance area 520.

In this example, the software guidance learning algorithm 524 can begin with the monitoring system 1105 being on. Once it is on, the first check can be whether or not a stated threshold has been reached 1110. The following provides one exemplary illustration of the stated threshold having been met. After this example, the path for the stated threshold not having been met is provided. This stated threshold can be received by user-defined parameters or methods and systems 102 default settings 1170 that contains the criteria for the trigger 1040. One example of the trigger can be the number or percentage of fields in certain statuses; however, per the learning algorithm itself and/or receiving user decisions, other ways to identify and provide key points can be utilized 1170. Continuing on the decision path of the criteria being reached, the software usage guidance result per the specified associated trigger (may or may not be displayed), background information, and tip itself can be formulated to be displayed, and various information and statistics, such as, user 505, date/time, trigger, background information, and the tip itself, may be placed in the database 1125.

Having the data for the guidance result, the software usage guidance learning algorithm 524 can now focus toward determining where to place the new guidance result. One example is through the software usage guidance area 520, and other examples are through the notification area 698, 1197, on the Administrative screen (per explanation of FIG. 15) 1197, and/or by changing the look of an object on the screen to be more obvious (i.e., through color, font, line type, and/or enlargement, etc) 1197. These can be depicted at any location on the screen as well. For this explanation, the example of the software usage guidance area 520 can be pursued although others are applicable and are understood to be covered under other examples of the present invention. One of ordinary skill in the art would appreciate that there are various ways the software usage guidance area could be organized and displayed, and examples of the present invention are contemplated for use with any organization and display style for such software usage guidance area.

Continuing with this example, the software usage guidance learning algorithm 524 can utilize the number of current tips versus the maximum number allowed to show according to the received user-defined parameters or methods and systems defaults 1130, 1135. If the maximum number to display has not been exceeded, the latest tip can be placed at the top of the Current tip list 1005, 1185, and the tips can be sent to the screen 1165. The monitoring system can continue to run 1105, but this cycle is completed.

If the maximum number to display in the Current tip section 1005 has been exceeded, the earliest provided current tip can be moved to the recent tip list 1010, 1140, and the move date/time can be captured in the database 1140. Before finalizing the placement in the Recent tip list 1010, the methods and systems 102 can check to see if the maximum number of recent tips in the recent tip list 1010 has been exceeded by moving this one 1145. This recent list 1010 threshold for the maximum number to show can be determined by received user-defined parameters or methods and systems 102 default settings 1150. If the threshold is not exceeded, the least new Current tip can be placed at the top of the Recent tip list 1010, 1190, and the tips are sent to the screen 1165. The monitoring system can continue to run 1105, but this cycle is completed.

If the number of Recent tips to display has been exceeded, the earliest Recent tip can be placed at the top of the Archive tip list 1015, 1155, and the move date/time can be captured in the database 1155. Before finalizing the placement in the Archive tip list 1015, the methods and systems 102 can check to see if the maximum number of archive tips in the Archive tip list 1015 has been exceeded by moving this one 1175. This archive list 1015 threshold for the maximum number to show can be determined by received user-defined parameters or methods and systems 102 default settings 1160. If the threshold is not exceeded, the oldest Recent tip can be placed at the top of the Archive tip list 1015, 1192, and the tips are sent to the screen 1165. The monitoring system can continue to run 1105, but this cycle is completed.

If the number of Archive tips to display has been exceeded, the oldest Archive tip is managed according to the request of the received user-defined parameters and/or methods and systems 102 defaults, and the move date/time is captured 1180. The received user-defined parameters or methods and systems default settings can specify what to do with the oldest archive tips that, if included, exceed the threshold—for example, they could be deleted or show up in a different color, etc 1195. In the meantime, all the appropriate guidance results and corresponding placement changes can be sent to the screen 1165. The monitoring system can continue to run 1105, but this cycle is completed.

Going back to a path that was not discussed, yet, we start at whether or not the stated threshold was reached 1110. Since the above describes the path for a stated threshold having been met, this describes when the stated threshold is not met. When it is not met, the derived threshold is checked 1115. An example of the derived threshold can include the threshold's occurrence through systematic steps and processes that self-regulate the adjustment of thresholds by data obtained through monitoring user activities or other learned contributions to the algorithms that lead to milestone achievements/measurements. Examples of milestone achievements/measurements are: completing a source, the time between progress of certain thresholds (i.e., % WIP fields to % Finalized fields, etc), etc 1120. Further, continuing an example, the methods and systems 102 can suggest methods for accelerating (and/or for warning the user of delays for) milestone achievements/measurements based on historical usage patterns 1120.

One exemplary illustration of the latter is if the methods and systems usage indicates an abnormal time for the progress of 60% WIP to 80% WIP fields, the methods and systems 102 may provide a software usage guidance result 520 that alerts the user of a warning of this (i.e., “Your project is currently taking 150% longer than other projects of this size.”) and potentially a suggested action to take (“Others in this situation often use the comparison functionality. Click here to learn more about this functionality.”). This is just one example of the implementation. There are endless scenarios for this, including topics that can be programmed systematically immediately and those that will initially require a human to review and analyze the captured data for behavior that can then be monitored and included systematically (See FIG. 15 for more on the Administration Management of information). It is understood that the additional examples, stated explicitly or not, are contemplated for use in examples of the present invention. One of ordinary skill in the art would appreciate that there are various implementations that could be utilized with examples of the present invention, and examples of the present invention are contemplated for use with any such implementation.

Finalizing the examples discussed for FIG. 11, if the derived threshold is not met, the monitoring system can continue to run 1105, but this cycle is completed. If the derived threshold is met, the same paths as described above occur, starting with the software usage guidance result per the specified associated trigger (may or may not be displayed), background information, and tip itself potentially being formulated to be displayed, and various information and statistics, such as, user 505, date/time, trigger, background information, and the tip itself, being captured potentially being placed in the database 1125.

FIG. 12, FIG. 13, FIG. 14, and FIG. 16 provide examples of the View Management area 565 in more detail. FIG. 12 can present the view for the data mapping requirements themselves. FIG. 13 can illustrate the summary by field plus source details view. FIG. 14 can show the summary by source plus field details view, and FIG. 16 can represent the data dictionary view.

FIG. 12 can provide the view of the data mapping requirements themselves. The purpose of this view can be two-fold: to provide the developer who is creating the data warehouse (and/or field mapping results) the actual data mapping requirements and to provide another view for any user 505 for reference (in one non-limiting example, as a system of record) and/or validation. In this view, the data mapping requirements can be presented in the view management area 565 detail section 1202. In other views, there can also be a summary section. Examples for this section are described in the FIG. 13 and FIG. 14 explanations.

The columns in the view management area 565 detail section 1202 in this example are Source Display Name 1205, Source Type 1240, Source Field Display Name 1210, Target Display Name 1215, Target Field Display Name 1220, Direct Lineage/ETL Rule 1225, Full Lineage/ETL Rule 1230, Target Fact/Dimension 1235, Source Path 1245, Source Field Path 1250, Target Path 1255, Target Field Path 1260, Source Original Name 1265, Source Field Original Name 1270, Target Original Name 1275, Target Field Original Name 1280, Source Description 1285, Source Field Description 1290, Target Description 1295, and Target Field Description 1297.

The source display name 1205 can be the received name for that source. If the source was created by an import and not changed by the user 505, it can be the original source name 1265 received per the import. If not, it can be the received the name the user 505 prefers. Similarly, the source field display name 1210 can be the received name of the field. If the source was created by an import, the source field display name 1210 can be the header name received per the file that was imported if the user 505 did not change it. The source field original name 1270 can be the received user-provided name of the field unless the file was imported, in which case it can be the header name in the file that was imported. The same can hold true for the target display name 1215, target original name 1275, target field display name 1220, and target field original name 1280 (except that it can apply for the receiving source, or target, as it is normally called in a data warehouse or other data store).

The source type 1240 can be received as either report, standard, DW Schema, or user-defined. The source types may be filtered by the source type filters 970, 975, and 977 (and user-defined, if specified) and/or on one or more perspectives, as in examples including, but not limited to, the requirements specified 972 and/or the implementation of those requirements 974.

Direct Lineage/ETL Rule 1225 can show the direct source/field path from the initial source/field through all intermediate fields to that target field. The Full Lineage/ETL Rule 1230 can show the entire lineage into and out of that field, including sources/fields that may only be related indirectly.

Target Fact/Dimension 1235 can be the received setting for the user-defined property stating if the target field is a fact or a dimension. If this is populated, it can indicate that the target is the associated fact or dimension table.

Source path 1245 can be the directory and file name of that source when it was imported or n/a if it was manually created or copied from an existing source. Source Field Path 1250 can be the heading or XML path for an imported file (per the type of file) or n/a if not imported. Target Path 1255 can be the same as Source Path 1245 except it can be for the receiving source, or the source better known in the data warehousing industry as the target. When a source is treated as a target, it may no longer has a ‘path’ since it can be a result of the direct mapping from fields in one or more source(s) 1265, 1270 and/or ETL Rules 1230. Regardless, this information can be retained, if available, for the purpose of tracking data lineage. The same relationship can exist for the Target Field Path 1260 and Source Field Path 1250, the Target Original Name 1275 and the Source Original Name 1265, and the Target Field Original Name 1280 and the Source Field Original Name 1270.

The Source Description 1285 can be the received user-provided explanation of the source, and the Source Field Description 1290 can be the same for the fields within the source. It could also be system-provided if the source is connected to a database or other file type to which the description field can be identified and captured. The same can hold true for the Target Description 1295 and Target Field Description 1297 (with the now normal exception of this being for the receiving source, or target).

The Report Sources 970, Standard Sources 975, DW Schema Sources 977, requirements specified 972, and the implementation of those requirements 974 filters, and the Project Explorer Window 640 are also available in this view.

FIG. 13, the summary by field plus source details view, introduces a summary section 1302. This view shows an example of the field summary in the view management area 565 summary portion 1302 and the source details in the view management area 565 detail portion 1202. The purpose of this view can be to quickly provide an understanding of the usage and coverage of each field. This can allow for quick prioritization, based on frequency of usage in one example, on which fields to concentrate first, and this can allow for quick validation by focusing on the amount of coverage (i.e., % completed), in one example, for each field.

The frequency of usage may be determined for fields used on reports only; however, for completeness, field summary information can be available for standard sources and for all types of sources (report, standard, DW Schema, and user-defined) combined or individually. Additionally, the summary portion 1302 can show the percentage coverage of the sources that utilize the particular field. This can allow the user 505 to quickly identify his/her progress by field.

The headings in the summary portion 1302 for this view may include Field Name 1210, Field Description 1290, Data Lineage/ETL Rule 1305, No. Report Sources 1310, % Report Sources Completed 1315, No. Total Sources 1320, % Total Sources Completed 1325, No. Standard Sources 1330, % Standard Sources Completed 1335, No. DW Schema Sources 1340, and % DW Schema Sources Completed 1345. The display field name 1210 column can include all display field names from all sources, and the description 1290 can be the methods and systems 102 chosen explanation of the purpose of the field based on the most frequently written definition or the first one if none occur more than once or there is no clear more frequently used definition. Clicking the build button in the data lineage/ETL rule column 1305 can show the lineage for the field 1210 specified for all sources.

The column No. Report Sources 1310 can provide the count of the report type sources for that display field name 1210, and the column % Report Sources Completed 1315 can provide the percentage of report type sources for that field name 1210 that are ‘Finalized’ or ‘Ignored’.

Similarly, the No. Total Sources 1320, No. Standard Sources 1330, No. DW Schema Sources 1340 can show the count for that field name 1210 of all sources, standard type sources, and DW Schema source types, respectively while the % Total Sources Completed 1325, the % Standard Sources Completed 1335, and the % DW Schema Sources Completed can show the percentage of all sources, standard type sources, and DW Schema type sources, respectively, that have a status of ‘Finalized’ or ‘Ignored’ for that field name 1210.

The main focus for this view can be for report type sources. As a result, the default setting can be that the order of information is for report type sources, then totals, then the other source types. Changes for this view can be received based upon user 505 selections to include user-defined source types and the order of the columns displayed.

When a particular field, such as Weight 1380, is selected, the associated sources can be listed in the view management area 565 detail portion 1202. The selected field can adhere to the Show/Hide Report Sources 970, Show/Hide Standard Sources 975, Show/Hide DW Schema Sources 977, Show/Hide per Requirements 972, and/or Show/Hide per Implementation 974 filters.

Checking the box for Show/Hide Report Sources 970 can show report sources and unchecking it can hide them. The same situation can occur for the Show/Hide Standard Sources 975, DW Schema Sources 977, user-defined filters (if specified per FIG. 9 explanation), Show/Hide per Requirements 972, and/or Show/Hide per Implementation 974. Further, if the user unchecks all filters, he/she can be alerted that, because these are the only types of sources, unchecking all of them may not show any sources.

When a field selected is received from the summary section 1302, the columns shown in the detail portion 1202 can be: Source Original Name 1265, Source Display Name 1205, Finalized/Ignored—Field 1385, % Finalized/Ignored—Total 1390, Source Description 1285, Source Path 1245, Data Lineage/ETL Rules 1350, Source Type Info 1355, No. Sources In Dir/Total 1360, No. Sources Out Direct/Total 1365, and the Created Method 1370.

The Source Original Name 1265, Source Display Name 1205, Source Description 1285, and Source Path 1245 can be as previously described. The Finalized/Ignored—Field 1385 can be the Boolean statement of whether or not the selected field (weight 1380 in this case) for that source has received a final decision. This can be determined by the receipt of the user choices indicating in the field's properties if that field is finalized or ignored (see earlier discussions for further explanations). The % Finalized/Ignored—Total 1390 can be the percentage of fields in that source that have received a final decision.

Upon receiving the click of the build button for the data lineage/ETL Rules 1350, the selected field's 1210 (and weight 1380 in this case) lineage and ETL rules for that source can be shown. The Source Type Info 1355 can provide a link to the attributes that correspond to that source type, i.e., report, standard, or DW schema (or whatever the user has defined per FIG. 9 explanation).

Per the data lineage/ETL rules 1350, a field can have other fields that directly feed it and fields to which it directly contributes. In the columns No. Source In Dir/Total 1360 and No. Sources Out Direct/Total 1365, the first number, 4 and 1, respectively, for row Load 1375, can represent the direct connections just described. Certainly, fields coming in or out can be fed by other fields and feed other fields. As a result, these can be the extended, not direct, relationships of the source's field. The combined direct and extended number of fields can be represented by the numbers 6 and 2, respectively, in the columns No. Source In Dir/Total 1360 and No. Sources Out Direct/Total 1365.

Created method 1370 can be a more generic category of how the source came into existence—i.e., Excel, XML via an import, database connection type, etc, or manually.

FIG. 14 illustrates an example of the summary by source plus field details view, which can show the source summary in the view management area 565 summary portion 1302 and the field details in the view management area 565 detail portion 1202. The purpose of this view can be to quickly provide an understanding of the progress and coverage of each source and to quickly dive deeply into fields as necessary. This can provide more of a ‘mass’ view of the project versus a working view per the source management work area 510.

The sources can be listed in the view management area 565 summary portion 1302 per the Show/Hide Report Sources 970, Show/Hide Standard Sources 975, DW Schema Sources 977 filters (and user-defined per FIG. 9 explanation), Show/Hide per Requirements 972, and/or Show/Hide per Implementation 974. The behavior of these filters can be as described per FIG. 12 and FIG. 13 except that in this view, the numbers represented in the summary portion 1302 can include results per the source type filters 970, 975, 977 and requirements/implementation perspectives 972, 974

The headings in the summary portion 1302 for this view may include Source Display Name 1205, Finalized % 1402, No. Total Fields 1405, No. WIP Fields 1407, No. Not Started Fields 1410, No. Finalized (Only) Fields 1412, No. Ignored Fields 1415, No. Sources In Dir/Total 1360, No. Sources Out Dir/Total 1365, Source Description 1285, Data Lineage/ETL Rules 1350, Source Path 1245, Created Method 1370, Source Type Info 1355, and Source Original Name 1265. The columns Source Display Name 1205, No. Sources In Dir/Total 1360, No. Sources Out Dir/Total 1365, Source Description 1285, Data Lineage/ETL Rules 1350, Source Path 1245, Created Method 1370, Source Type Info 1355, and Source Original Name 1265 can have the same meaning as previously indicated per the FIG. 12 and FIG. 13 explanations.

The Finalized % 1402 column can indicate the percentage complete of the source. This can be based on the number of fields in the source that have been identified as finalized or ignored and total numbers of fields in the source. The No. Total Fields 1405 can indicate the total number of fields in the source. The No. WIP Fields 1407 can identify the number of fields that have a line to it and/or an ETL rule specified for it while the No. Not Started Fields 1410 can indicate the number of fields that do not have either a line to it or an ETL rule specified for it.

The No. Finalized (Only) Fields 1412 can show the number of fields that are finalized for that source per the received Finalized properties of those fields. The same can hold true for the No. Ignored Fields 1415 but for the Ignored properties of those fields.

When a particular source, such as Ready to Send Loads 1460, is selected, the associated fields can be displayed in the view management area 565 detail portion 1202. The columns shown in the detail portion 1202 are Field Original Name 1417, Field Display Name 1210, Status 1420, No. Total Sources 1320, No. Sources Ignored 1425, Field Description 1290, Lineage/ETL Rule 1305, Data Type 1427, Valid Values 1430, Default Value 1435, Null Allowed 1440, Fact/Dimension 1445, Created Info 1450, and Updated Info 1455.

The columns Field Display Name 1210, No. Total Sources 1320, Field Description 1290, and Data Lineage/ETL Rule 1305 can have the same meaning as previously indicated per the FIG. 12 and FIG. 13 explanations. The field original name 1417 can be the received name of the field per the header name in the file that was imported or the user override (like the source field original name 1270). The Status 1420 can alert the user of the stage of the field 1417. The eligible statuses can be Not Started 910, WIP (work in progress) 905, Finalized 915, and Ignored 920, as previously described.

No. Sources Ignored 1425 can be the number of unique sources in which that field has the property of ‘Ignored’ checked. Data Lineage/ETL Rule 1305 can provide the complete data lineage/ETL Rule for that field for the selected source 1255. Data Type 1427, Valid Values 1430, Default Value 1435, and Null Allowed 1440 can be the received normal database field properties and can be derived by the methods and systems 102 or user-specified. Fact/Dimension 1445 can state the received type of object, a fact or a dimension, within the star schema the field has been assigned by the user 505 (or methods and systems 102 suggested) to be as well as the dimension name it can be a part of (if a dimension) or associated to (if a fact). Created Info 1450 and Updated Info 1455 are hyperlinks that can alert the user of who created or updated the info and when, respectively.

FIG. 16 illustrates an example of the data dictionary, which can be very similar to FIG. 14, the summary by source plus field details view in the view management area 565. The purpose of this view can be to quickly provide an understanding of the progress by project and/or individual sources as well as to dive deeply into the sources and fields as necessary.

This view can be presented by Project and then grouped by each Source 1302 with its fields detailed 1202. The heading information for the Project can include the Project Name 1605, Finalized % 1602, No. Total Fields 1605, No. WIP Fields 1607, No. Not Started Fields 1610, No. Finalized (Only) Fields 1612, No. Ignored Fields 1615, No. Sources 1620, Created By 1630, Created Date/Time 1635, Updated By 1640, Updated Date/Time 1645, and Assignees 1650.

The columns Finalized % 1602, No. Total Fields 1605, No. WIP Fields 1607, No. Not Started Fields 1610, No. Finalized (Only) Fields 1612, and No. Ignored Fields 1615 can have the same meaning as previously indicated per the FIG. 14 explanations, except as a summary for the entire project. The column No. Sources 1620 can be a count of the sources within the project. The Project Description 1625 column can be the description of the project as received by the methods and systems 102 from the user 505. The Created By 1630 and Created Date/Time 1635 columns can be the creator of the project and date/time stamp for when the project was created as captured by the methods and systems 102. The Updated By 1640 and Updated Date/Time 1645 columns can be the user name of the last user 505 to change the project and corresponding date/time stamp as captured by the methods and systems 102. The Assignees 1650 column can be any other users assigned to the project as received by the methods and systems 102.

Once the project information is displayed, the pairings of each Source and its fields can be displayed 1302, 1202 in FIG. 16. The Source Display Name 1205 column in this view can be shown as the heading for the Source table 1302. The other columns as explained per FIG. 14 can continue to be shown in FIG. 16. The columns for the Field Detail 1202 as explained in FIG. 14 can also continue to be shown for the data dictionary view explained per FIG. 16. Further, the sources can be listed in the view management area 565 summary portion 1302 per the Show/Hide Report Sources 970, Show/Hide Standard Sources 975, and DW Schema Sources 977 filters (and user-defined per FIG. 9 explanation), Show/Hide per Requirements 972, and/or Show/Hide per Implementation 974. The behavior of these filters can be as described per FIG. 14.

For all views in FIG. 12, FIG. 13, FIG. 14, and FIG. 16 the methods and systems 102 offer the user 505 the choice for displaying or not particular columns, adding columns not shown, their order, and sorting and filtering on the headings for both the summary and detail views 1302, 1202. Also, one example is described; however, there are many other examples, including additional, changed, or removed fields on the views as well as various presentation styles being utilized. One of ordinary skill in the art would appreciate that there are various display styles that could be used, and examples of the present invention are contemplated for use with any organization and display style for such software usage guidance results.

FIG. 15, FIG. 15A, FIG. 15B, FIG. 15C, and FIG. 15D illustrates one example of the Administrative statistics area as well as the licensing management. The Administrative statistics area 562 can consist of various statistics representing the use of the system. The purpose can be to provide the system administrator or other typically higher level users the ability to understand what and how functionality is used within the system to continuously improve the user experience of the product, resource allocation, and project monitoring.

This can be accomplished by showing progress of the various licensee types, their clients, and their project(s); user interaction with the system; the usage of the results of the software usage guidance algorithm for improved effectiveness; the comparison algorithm results usage for improved effectiveness; and by allowing the administrator to filter on various attributes of the methods and systems 102. FIG. 15 introduces the example and FIGS. 15A, 15B, 15C, and 15D expand upon the example. FIG. 15 can show the non-limiting examples of the sections in the administration statistics area: Filters 1502 per FIG. 15A, Software Guidance 1504 per FIG. 15B, Comparison (Summary Stats by Target) 1506 per FIG. 15C, and Product Usage 1508 per FIG. 15D.

It makes sense to start with FIG. 15A for the Filters 1502 since this can provide a description for the different types of licenses anticipated for one possible example and can provide a base understanding for the remaining sections. The Filters 1502 section can consist of the Customers 1510, License Type 1528, and Stats Type 1532 subsections. All subsections can provide normal expand/collapse functionality 1541 for ease of viewing and filtering 1597 on only the points of interest quickly.

In one example, the License Type 1528 subsection can include the software owner (or assignee) 1599, Vendor/Consultant 1530, Client (Admin) 1523, Standard (Non-Admin) 1525, and Read Only 1527. The highest level of license can be the software owner (or assignee) 1599. This can be followed by the Vendor/Consultant type 1530, then the Client (Admin) type 1523, then Standard (Non-Admin) type 1525, and finally the Read Only type 1527.

Continuing the example, the software owner (or assignee) 1599 can have unlimited restrictions on the number and types of licenses. The Vendor/Consultant level 1530 can purchase any number of the remaining types of licenses (not software owner or assignee) and assign them accordingly. As a result, the Vendor/Consultant level 1530 can have all read/write capability that is not a software owner (or assignee) level 1599. The Vendor/Consultant license 1530 can authorize the creation of as many of the other users 505 for the types of licenses as purchased. A one-to-many relationship with the Client (Admin) 1523 license types can exist.

The Client (Admin) license type 1523 can offer the read/write capability for any assigned client name as provided by the software owner (or assignee of the software owner) or Vendor/Consultant 1530 and can have the ability to create as many other users 505 for the Standard (Non-Admin) 1525 and Read Only 1527 types as purchased.

The Standard (Non-Admin) type 1525 can offer read/write capability for projects, but that license level may not be able to create any users 505 for any licensing. The Read Only licensee 1527 may be able to view the information for any project to which they are assigned.

With the non-limiting licensing background example 1528 explained, it is now time to look at the Customers 1510 filter. It also can have the normal expand/collapse functionality 1541, but this section can feature the hierarchy of the types of licensed users and their projects. The view depicted can be for the software owner (or assignee) user 1520 such that all Vendor/Consultants 1512 and all direct software owner (or assignee) customers can be shown by name. Under each Vendor/Consultant level 1512 can be the Clients 1514 by name. Under each Client 1514 can be the projects 1516 by name. Finally, under each Project 1516 can be the projects' users 1518. Another example could be a view by User 1518 directly under Client 1514 and the projects 1516 under the users 1518.

For the purposes of the filtering, the software owner (or assignee) level 1520 can be at the same level of the Vendor/Consultants 1512. The rest of the hierarchy can be similar. Under the software owner (or assignee) level 1520 are the Clients 1522 by name. Under each Client 1522 are the projects 1524 by name. Finally, under each Project 1524 are the projects' users 1526. Another example could be a view by User 1526 directly under Client 1522 and the projects 1524 under the users 1526. In all cases, the methods and systems 102 can provide the capability to expand/collapse 1541 and check the filter boxes on/off as desired (examples shown per 1597). The hierarchy described is one example, and other examples that may or may not be explicitly stated should be understood as to be contemplated for use with examples of the present invention. One of ordinary skill in the art would appreciate that there are various hierarchies that could be used, and examples of the present invention are contemplated for use with any appropriate hierarchy.

The Stats Type filter 1532 can provide the ability to show/hide certain stats windows or types of stats within a window. The Software Usage Guidance 1534 and Comparison filters 1535 can show or hide those specific entire windows 1504, 1506, respectively. The Product Usage 1543 filter can show or hide that entire window 1508 or the individual types of information related to sources, fields, or users 1545. The filtering can take place by receiving clicks on/off in the filter boxes as desired per check boxes 1597 (All categories and subcategories have this filtering capability whether or not they are labeled 1502.).

The Software Usage Guidance 1504, Comparison 1506, and Product Usage 1508 windows can start out presenting the information as rolled up summary data. The filters 1502, 1597 and expand/collapse 1541 functionality can be used to show, hide, include, and/or exclude certain data and to drill down to more details. The descriptions here take on the summary explanation; however, it would be understood by one of ordinary skill in the art to be covered by examples of the present invention that the information can be taken to the individual detailed level per the use of the capabilities just mentioned.

Per FIG. 15B, the Software Guidance 1504 window may provide the columns Vendor/Consultant 1536, Client 1538, Avg No. Current Tips Shown 1542, Avg No. Recent Tips Shown 1547, Avg No. Archive Tips Shown 1549, Avg Time to Review 1544, Avg Time to Implement 1546, Avg Time to Move to Recent 1548, Avg Time to Move to Archive 1550, and Avg Time to Delete 1552. The normal collapse/expand 1541 functionality can work with the columns Vendor/Consultant 1536 and Client 1538.

The Avg No. Current Tips Shown 1542, Avg No. Recent Tips Shown 1547, and Avg No. Archive Tips Shown 1549 can provide the average number of current, recent, and archive tips, respectively. Since these are configurable, it can vary across projects, users, customers, etc, so this type of information can be used, at a minimum, to determine what the best default values are for these.

The Avg Time to Review 1544 can represent the time between the tip being provided and when the methods and systems 102 receive a click on it. Avg Time to Implement 1546 can be the time between the methods and systems 102 receiving a click on the guidance result and when any part of it is implemented. Avg Time to Move to Recent 1548 can display the time the guidance result is clicked in the ‘Current Tip’ category 1005 and the time the request to move it to the recent bucket is received (potentially if manually requested). Similarly, the Avg Time to Move to Archive 1550 can be the time the guidance result lands in the ‘Recent Tip’ category 1010 and the time the request to move it to the archive bucket is received (potentially if manually requested). Finally, the Avg Time to Delete 1552 can be the time a guidance result is first presented in the ‘Current Tip’ category 1005 and the time the delete is received for it.

Referring now to FIG. 15C, the Comparison (Summary by Target) 1506 window may have the columns Vendor/Consultant 1536, Client 1538, Avg No. Fully Approved Matches Accepted 1554, Avg No. Fully Approved Matches Rejected 1556, Avg No. Conditionally Approved Matches Accepted 1558, Avg No. Conditionally Approved Matches Rejected 1560, Avg No. Suggestions Made 1562, Avg No. Suggestions Fully Approved 1564, Avg No. Suggestions Conditionally Approved 1566, Avg No. Suggestions Rejected 1568, and Avg No. Sys Int Used 1569. The Vendor/Consultant 1536 and Client 1538 can be as previously described, including the filtering 1597 and expand/collapse 1541 functionality.

The Avg No. Fully Approved Matches Accepted 1554 can be the average number of times fully approved matches are kept and processed through the ‘Accept’ button 722 on the Comparison screen 585. The Avg No. Fully Approved Matches Rejected 1556 can be the average number of times fully approved matches are removed or their approval category is changed before being processed through the ‘Accept’ button 722 on the Comparison screen 585. The same can be true for the Avg No. Conditionally Approved Matches Accepted 1558 and Avg No. Conditionally Approved Matches Rejected 1560 per the Conditionally approved status rather than the Fully approved.

The previous fields referenced potentially prior decisions suggested by the comparison learning algorithm 522 that incorporated any feedback received. The next fields, Avg No. Suggestions Made 1562, Avg No. Suggestions Fully Approved 1564, Avg No. Suggestions Conditionally Approved 1566, and Avg No. Suggestions Rejected 1568 involve the suggestions that are made by the comparison learning algorithm 522 without receiving prior feedback. Avg No. Suggestions Made 1562 can be the count for new suggestions made, the Avg No. Suggestions Fully Approved 1564 can be the count for the new suggestions that were fully approved. The Avg No. Suggestions Conditionally Approved 1566 can be the count for new suggestions that were conditionally approved, and the Avg No. Suggestions Rejected 1568 can be the count for new suggestions that were rejected. The field Avg No. Sys Int Used 1569 can identify how many times the ‘System Integration Menu’ is invoked.

Utilizing FIG. 15D, the Product Usage 1508 section may have the columns Vendor/Consultant 1536, Client 1538, User 1570, Project 1572, % Complete 1574, Avg No. Total Sources 1576, Avg No. Report Sources 1578, Avg No. Standard Sources 1580, Avg No. DW Schema Sources 1582, Avg No. Sources Created per Session 1584, Avg No. Sources Created per Import per Session 1586, Avg No. Fields per All Sources 1592, Avg No. Fields per Report Sources 1594, Avg No. Fields per Standard Sources 1596, Avg No. Fields per DW Schema Sources 1598, Avg No. Fields Created per Session 1501, Avg Time to First Source Create 1588, Avg Time to Latest Source Create 1590, Avg Time Logged In 1531, Avg Time to First Login 1503, Avg No. Role Changes 1505, Avg No. Users 1507, Avg No. Vendor/Consultant Users 1509, Avg No. Client Users 1511, Avg No. Standard Users 1513, Avg No. Read Only Users 1515, Avg Time Btwn Log Ins 1533, Avg Time Btwn User Mgmt 1517, Avg Time Btwn User Creation 1519, and Avg Time Emulating 1521.

The Vendor/Consultant 1536 and Client 1538 are as previously described, including the filtering 1597 and expand/collapse 1541 functionality. In one example, the columns Project 1572 and User 1570 can be extensions of Vendor/Consultant 1536 and Client 1538 concepts and could have also been included in FIG. 15B and FIG. 15C. Another example is that the software owner (or assignee), which is not shown in FIG. 15, 15B, 15C, or 15D, can be present in all portions of the administrative statistics area 562 and that various versions of hierarchy can be used for the expand/collapse 1541 functionality for all of the different licensing levels.

The column % Complete 1574 can be a count of the number of fields whose properties have been checked on for Finalized or Ignored divided by the total number of fields in the project. This can be a moving target as the methods and systems 102 can receive a new source at any time.

The Avg No. Total Sources 1576, Avg No. Report Sources 1578, Avg No. Standard Sources 1580, and Avg No. DW Schema Sources 1582 can represent across the entities selected per the filters 1502 the number of those types of sources per entity.

The Avg No. Sources Created per Session 1584 can be provided to determine how many sources are created per session. When the averages are understood, this can be useful for determining resource allocation and progress expectations (i.e., the latter to note if a project is progressing as expected or faster or slower than expected). The Avg No. Sources Created per Import per Session 1586 can be important to understand to realize how the tool is being used to create sources. This can then be utilized within the software guidance system to alert project clients of potential approaches that are more efficient than they may be using. Avg Time to First Source Create 1588 and Avg Time to Latest Source Create 1590 can also be used to help determine utilization of the tool.

Avg No. Fields per All Sources 1592, Avg No. Fields per Report Sources 1594, Avg No. Fields per Standard Sources 1596, Avg No. Fields per DW Schema Sources 1598, and Avg No. Fields Created per Session 1501 can be used for knowledge of how the tool is utilized and to help set expectations of new clients.

Avg Time Logged In 1531, Avg Time to First Login 1503, Avg No. Role Changes 1505, Avg No. Users 1507, Avg No. Vendor/Consultant Users 1509, Avg No. Client Users 1511, Avg No. Standard Users 1513, Avg No. Read Only Users 1515, Avg Time Btwn Log Ins 1533, Avg Time Btwn User Mgmt 1517, Avg Time Btwn User Creation 1519, and Avg Time Emulating 1521 can also be provided to help determine how the tool is used and to help set expectations of new clients. FIG. 15D depicts many columns and is showing them in two rows; however, this is just one example of how they can be presented, and one of ordinary skill in the art would understood to that there are numerous manners in which they could be presented, and examples of the present invention are contemplated for use with any appropriate presentation.

FIGS. 15, 15A, 15B, 15C, and 15D depicts its sections as tables; however, another example not displayed but included in this application is charts, graphs, dashboards, etc, of the tabular information displayed. This capability could be utilized through an API (application programming interface) of another product and/or as part of the methods and systems 102. Further, additional metrics could be added to or removed from the tables and/or charts, graphs, dashboards, etc, and these examples would also be understood to be contemplated for use with examples of the present invention. One of ordinary skill in the art would appreciate that there are numerous additional metrics that could be used with examples of the present invention, and examples of the present invention are contemplated for use with any appropriate additional metrics. Additional examples to be covered by examples of the present invention can include: showing certain information as totals, standard deviations, etc, instead of, or in addition to, averages. Finally, the methods and systems 102 can receive which fields to display or not, in what order, and can provide and remember filtering and sorting requests for all columns.

Not depicted are the Administrative screens that receive the set up for managing licensing, permissions, roles, customers, users 505, projects, etc for creation, change, removal, including assignments and un-assignments. The various examples on the content and presentation would be understood as being contemplated for use with examples of the present invention. One of ordinary skill in the art would appreciate that there are various ways to present such content, and examples of the present invention are contemplated for use with any manner of presentation for such content.

While multiple examples are disclosed, still other examples of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented method that provides prioritization, requirements establishment, validation, and reference that can be used to create and reference a data warehouse or field mapping effort, said method comprising the steps of:
prioritizing one or more fields;
prioritizing one or more sources;
performing data profiling on said one or more fields and one or more sources;
providing results of said data profiling;
performing a second prioritizing of said one or more fields based at least on the data profiling;
comparing one or more of said one or more fields for auto mapping suggestions and for contribution to a learning process;
generating a set of auto mapping decisions for one or more of said one or more fields from said auto mapping suggestions;
displaying said set of auto mapping decisions;
capturing results of said auto mapping decisions for contribution to said learning process; and
merging said one or more fields from said one or more sources into one or more data stores.

2. The computer implemented method of claim 1, further comprising the steps of:
establishing data lineage for one or more of said one or more sources; and
displaying data lineage for one or more of said one or more sources.

3. The computer implemented method of claim 1, further comprising the steps of:
providing a user interface to establish data mapping and ETL rules in various formats;
displaying said data mapping and/or ETL rules requirements via said user interface in one or more formats; and
displaying a data dictionary, wherein said data dictionary provides a detailed explanation of properties and status of a project as well as a detailed explanation of one or more of said one or more sources, and one or more of said one or more fields.

4. The computer implemented method of claim 1, further comprising the steps of:
capturing statistics for one or more of said one or more fields and one or more sources;
capturing statistics of product usage; and
generating one or more sets of key statistics from said statistics for one or more of said one or more fields and one or more sources and said statistics of product usage.

5. The computer implemented method of claim 4, further comprising the steps of:
displaying a portion of said one or more sets of key statistics associated with field and source statistics; and
displaying a portion of said one or more sets of key statistics associated with said field and source statistics per one or more attributes associated with said field and source statistics.

6. The computer implemented method of claim 4, further comprising the steps of:
displaying key points of unused functionality in software for user knowledge and guidance, wherein said key points are obtained from said one or more sets of key statistics; and
managing provided key points of unused functionality in software.

7. The computer implemented method of claim 1, further comprising the step of applying said one or more sets of key statistics to enhance learning process for comparison suggestions.

8. The computer implemented method of claim 1, further comprising the step of applying said one or more sets of key statistics to enhance learning process for software improvements.

9. The computer implemented method of claim 1, further comprising the step of applying said one or more sets of key statistics to enhance learning process for automatically displaying key points of unused functionality in software.

10. The computer implemented method of claim 1, further comprising the step of capturing results of user decisions on one or more mapped fields for contribution to the learning process.

11. A computer implemented system that provides prioritization, requirements establishment, validation, and reference that can be used to create and reference a data warehouse or a field mapping effort, said system comprising:
one or more network connected computing devices,
wherein each computing device comprises a processor, a memory, one or more input/output interfaces, and one or more applications, and
wherein the one or more network connected computing devices are operably connected and are configured to:
prioritize one or more fields;
prioritize one or more sources;
perform data profiling on said one or more fields and one or more sources;
provide results of said data profiling;
perform a second prioritizing of said one or more fields based at least on the data profiling;
compare one or more of said one or more fields for auto mapping suggestions and for contribution to a learning process;
generate a set of auto mapping decisions for one or more of said one or more fields from said auto mapping suggestions;
display said set of auto mapping decisions;
capture results of said auto mapping decisions for contribution to said learning process; and
merge said one or more fields from said one or more sources into one or more data stores.

12. The computer implemented system of claim 11, wherein said one or more network connected computing devices are further configured to:
establish data lineage for one or more of said one or more sources; and
display data lineage for one or more of said one or more sources.

13. The computer implemented system of claim 11, wherein said one or more network connected computing devices are further configured to:
provide a user interface to establish data mapping and ETL rules in various formats;
display said data mapping and/or ETL rules requirements via said user interface in one or more formats; and
display a data dictionary, wherein said data dictionary provides a detailed explanation of properties and status of a project as well as a detailed explanation of one or more of said one or more sources, and one or more of said one or more fields.

14. The computer implemented system of claim 11, wherein said one or more network connected computing devices are further configured to:
capture statistics for one or more of said one or more fields and one or more sources;
capture statistics of product usage; and
generate one or more sets of key statistics from said statistics for one or more of said one or more fields and one or more sources and said statistics of product usage.

15. The computer implemented system of claim 14, wherein said one or more network connected computing devices are further configured to:
display a portion of said one or more sets of key statistics associated with field and source statistics; and
display a portion of said one or more sets of key statistics associated with said field and source statistics per one or more attributes associated with said field and source statistics.

16. The computer implemented system of claim 14, wherein said one or more network connected computing devices are further configured to:
display key points of unused functionality in software for user knowledge and guidance, wherein said key points are obtained from said one or more sets of key statistics; and
manage provided key points of unused functionality in software.

17. The computer implemented system of claim 11, wherein said one or more network connected computing devices are further configured to apply said one or more sets of key statistics to enhance learning process for comparison suggestions.

18. The computer implemented system of claim 11, wherein said one or more network connected computing devices are further configured to apply said one or more sets of key statistics to enhance learning process for software improvements.

19. The computer implemented system of claim 11, wherein said one or more network connected computing devices are further configured to apply said one or more sets of key statistics to enhance learning process for automatically displaying key points of unused functionality in software.

20. The computer implemented system of claim 11, wherein said one or more network connected computing devices are further configured to capture results of user decisions on one or more mapped fields for contribution to the learning process.
